(19) United States
(12) Patent Application Publication
(10) Pub. No.: US 2017/0064186 A1
(43) Pub. Date: Mar. 2, 2017

(54) FOCUS POSITION DETECTION DEVICE, FOCUS POSITION DETECTION METHOD, AND COMPUTER PROGRAM FOR FOCUS POSITION DETECTION

(71) Applicant: FUJITSU LIMITED, Kawasaki-shi (JP)

(72) Inventors: Shohei NAKAGATA, Kawasaki (JP); Megumi CHIKANO, Kawasaki (JP)

(73) Assignee: FUJITSU LIMITED, Kawasaki-shi (JP)

(21) Appl. No.: 15/224,693

(22) Filed: Aug. 1, 2016

(30) Foreign Application Priority Data
Aug. 31, 2015 (JP) 2015-171091

(51) Int. Cl. H04N 5/232

(52) U.S. Cl. CPC H04N 5/23212

(57) ABSTRACT

A focus position detection device calculates, for each shift amount calculation area contained in a measurement area defined on an image sensor, a local shift amount representing a shift between a first sub-image generated from first pixels and a second sub-image generated from second pixels and its confidence score, and corrects the confidence score based on at least one of the spacing between the first pixels, the spacing between the second pixels, and the amount of positional displacement between the first and second pixels in a direction orthogonal to the edge direction of a subject captured in the shift amount calculation area. Then, the focus position detection device calculates a representative value representing the distance between the image sensor and the focus position, by taking a weighted average of the local shift amounts of the respective shift amount calculation areas with weighting based on the corrected confidence scores.

### CROSS-REFERENCE TO RELATED APPLICATION

This application is based upon and claims the benefit of priority of the prior Japanese Patent Application No. 2015-171091, filed on Aug. 31, 2015, the entire contents of which are incorporated herein by reference.

### FIELD

The embodiments discussed herein are related to a focus position detection device and focus position detection method for detecting a focus position for a subject based on an image captured of the subject, and a computer program for implementing such focus position detection.

### BACKGROUND

Conventionally, an image capturing apparatus such as a digital camera or video camera is equipped with an automatic focusing system (generally known as auto focus) which, in order to generate a sharp image of a subject, automatically measures the distance to the subject and automatically focuses on the subject based on the result of the measurement.

Of such auto focus (AF) methods, a phase difference detection method is known which is one example of a method that utilizes beams passed through imaging optics. In the phase difference detection method, a beam reflected by a subject and passed through imaging optics is split into two beams and, from the displacement between the positions of the images of the subject formed on an image sensor by the two beams, the amount by which the image sensor is displaced in position from the focus position is obtained. Then, the focal point of the imaging optics is adjusted so that the positions of the images of the subject formed by the two beams coincide with each other. For example, in the phase difference detection method, an area in which the focus position can be detected by the phase difference detection method is defined on the image sensor. Then, in a plurality of solid-state imaging devices arranged in one row within that area, one of the two halves into which the light receiving face of each solid-state imaging device, located on the image side of the light-gathering microlens, is divided along a line perpendicular to the arranging direction of the solid-state imaging devices is masked, thereby obtaining the image of the subject corresponding to one of the beams. Further, in a plurality of solid-state imaging devices arranged in another row within that area, the other of the two halves into which the light receiving face of each solid-state imaging device, located on the image side of the light-gathering microlens, is divided along the line vertical to the arranging direction of the solid-state imaging devices is masked, thereby obtaining the image of the subject corresponding to the other beam.

A technique has been proposed which provides a plurality of such areas on an image sensor so that AF using the phase difference detection method can be performed on a plurality of locations on the image sensor (for example, refer to Japanese Laid-open Patent Publication No. 2007-24941). In the technique disclosed in Japanese Laid-open Patent Publication No. 2007-24941, when it is desired to detect a focus position in a particular area on the image sensor where it is not possible to detect the focus position using the phase difference detection method, the amount of defocus is detected with respect to each of a plurality of areas where focus detection using the phase difference detection method can be performed in the vicinity of the particular area, and the average value of the detected defocus amounts is used as the estimated defocus amount for the particular area.

### SUMMARY

In order to suppress image quality degradation, pixels to be used to generate images for phase difference detection, with the light receiving face of each pixel partially masked, may be arranged in a spaced apart manner across an area where focus detection using the phase difference detection method is possible. In this case, depending on the edge direction of the subject, the amount of shift between the two images of the subject may not be obtained accurately, and the amount of defocus from the focus position may become inaccurate, as a result of which the camera may not correctly focus on the subject.

According to one embodiment, a focus position detection device is provided. The focus position detection device includes a processor configured to: identify a plurality of shift amount calculation areas contained in a measurement area defined on an image sensor which is used to generate an image and which together with an optical system constitutes an image capturing device, each of the plurality of shift amount calculation areas having a plurality of first pixels for generating a first sub-image representing a subject captured in the shift amount calculation area and a plurality of second pixels for generating a second sub-image representing the subject captured in the shift amount calculation area, wherein a shift amount representing a shift between the subject on the first sub-image and the subject on the second sub-image varies according to a distance between the image sensor and a focus position achieved by the optical system for the subject; calculate, for each of the plurality of shift amount calculation areas, a local shift amount of the second sub-image relative to the first sub-image when the subject on the first sub-image and the subject on the second sub-image best coincide with each other, and a confidence score representing a degree of certainty of the local shift amount; correct, for each of the plurality of shift amount calculation areas, the confidence score based on at least one of a spacing between adjacent ones of the plurality of first pixels, a spacing between adjacent ones of the plurality of second pixels, and an amount of positional displacement between the plurality of first pixels and the plurality of second pixels in a direction orthogonal to an edge direction of the subject in the shift amount calculation area; and calculate a representative value representing the distance between the image sensor and the focus position achieved by the optical system, by taking a weighted average of the local shift amounts of the plurality of shift amount calculation areas with weighting based on the corrected confidence scores.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating one example of an arrangement of left pixels and right pixels in an AF area.

FIG. 1B is a diagram illustrating the relationship between the arrangement of the left pixels and right pixels illustrated in FIG. 1A and the left image and right image, respectively.

FIG. 2A is a diagram illustrating one example of the left and right images produced when a subject having a vertical edge is captured in an AF area.

FIG. 2B is a diagram illustrating one example of the left and right images produced when a subject having an edge parallel to the direction in which the left pixels and right pixels are arranged is captured in the AF area in FIG. 2A.

FIG. 3A is a diagram illustrating another example of the arrangement of the left pixels and right pixels in the AF area.

FIG. 3B is a diagram illustrating the relationship between the left image and the right image when the subject captured in the AF area in FIG. 3A has a vertical edge and when the left image is shifted to the left by two pixels with respect to the right image.

FIG. 3C is a diagram illustrating the relationship between the left image and the right image when the subject captured in the AF area in FIG. 3A has an edge parallel to the direction in which the left pixels and right pixels are arranged and when the left image is shifted to the left by two pixels with respect to the right image.

FIG. 4A is a diagram illustrating the distribution of left pixels and the distribution of right pixels when the left pixels and right pixels in the AF area of FIG. 2A are respectively projected along the direction of the edge.

FIG. 4B is a diagram illustrating the distribution of left pixels and the distribution of right pixels when the left pixels and right pixels in the AF area of FIG. 2B are respectively projected along the direction of the edge.

FIG. 5A is a diagram illustrating the distribution of left pixels when the left pixels in the AF area of FIG. 3B are projected along the direction of the edge.

FIG. 5B is a diagram illustrating the distribution of left pixels when the left pixels in the AF area of FIG. 3C are projected along the direction of the edge.

FIG. 6 is a diagram schematically illustrating the configuration of a digital camera as one example of an image capturing apparatus incorporating a focus position detection device.

FIG. 7 is a diagram illustrating one example of an arrangement of AF areas defined on an image sensor.

FIG. 8 is a diagram illustrating one example of sub-images generated from two pixel rows in the AF area illustrated in FIG. 7.

FIG. 9 is a functional block diagram of a control unit.

FIG. 10 is a diagram illustrating one example of the relationship between a measurement area and shift amount calculation areas.

FIG. 11A is a diagram illustrating the principle of equiangular linear fitting.

FIG. 11B is a diagram illustrating the principle of equiangular linear fitting.

FIG. 12 is a diagram for explaining how a pixel is projected along the edge direction.

FIG. 13 is a diagram illustrating by way of example the arrangement of the left and right pixels, the edge direction, and the distribution of projected left and right pixels.

FIG. 14 is a graph plotting the spacing between left pixels as a function of the edge direction for the arrangement of the left pixels depicted in FIG. 13.

FIG. 15 is a graph plotting the amount of positional displacement between the left and right pixels as a function of the edge direction for the arrangement of the left and right pixels depicted in FIG. 13.

FIG. 16 is an operation flowchart of a focus position detection process.

FIG. 17A is a diagram illustrating the local shift amounts in the respective shift amount calculation areas contained in the measurement area and their confidence scores when the confidence scores are not corrected.

FIG. 17B is a diagram illustrating the local shift amounts in the respective shift amount calculation areas contained in the measurement area and their confidence scores when the confidence scores are corrected in accordance with one embodiment or its modified example.

### DESCRIPTION OF EMBODIMENTS

A focus position detection device according to one embodiment will be described with reference to the drawings. The focus position detection device obtains a focus position for an entire measurement area defined on an image sensor, based on the shift amount and its confidence score detected between two images of a subject captured in each of a plurality of areas contained in the measurement area as areas where focus position detection using the phase difference detection method is possible. For this purpose, the focus position detection device estimates the edge direction of the subject in each area. Then, in each area, the focus position detection device obtains the spacing between pixels (hereinafter referred to as left pixels for convenience) used to generate one of the images of the subject for phase difference detection and the spacing between pixels (hereinafter referred to as right pixels for convenience) used to generate the other one of the images of the subject, the spacing being measured in a direction orthogonal to the edge direction. Further, in each area, the focus position detection device obtains the amount of positional displacement between the left and right pixels in the direction orthogonal to the edge direction. Then, in each area, the focus position detection device corrects the confidence score of the shift amount detected between the two images of the subject, based on the spacing between the left pixels and the spacing between the right pixels in the direction orthogonal to the edge direction and on the amount of positional displacement between the left and right pixels.

For convenience of explanation, each area where focus position detection using the phase difference detection method is possible will hereinafter be referred to as an AF area. In each AF area, a sub-image of the subject generated by a set of right pixels is referred to as the right image, and a sub-image of the subject generated by a set of left pixels is referred to as the left image.

To facilitate understanding, a description will be given of the effect that the relationship between the arrangement of the left pixels and right pixels in the AF area and the edge direction of the subject in the AF area will have on the measurement accuracy of the shift amount.

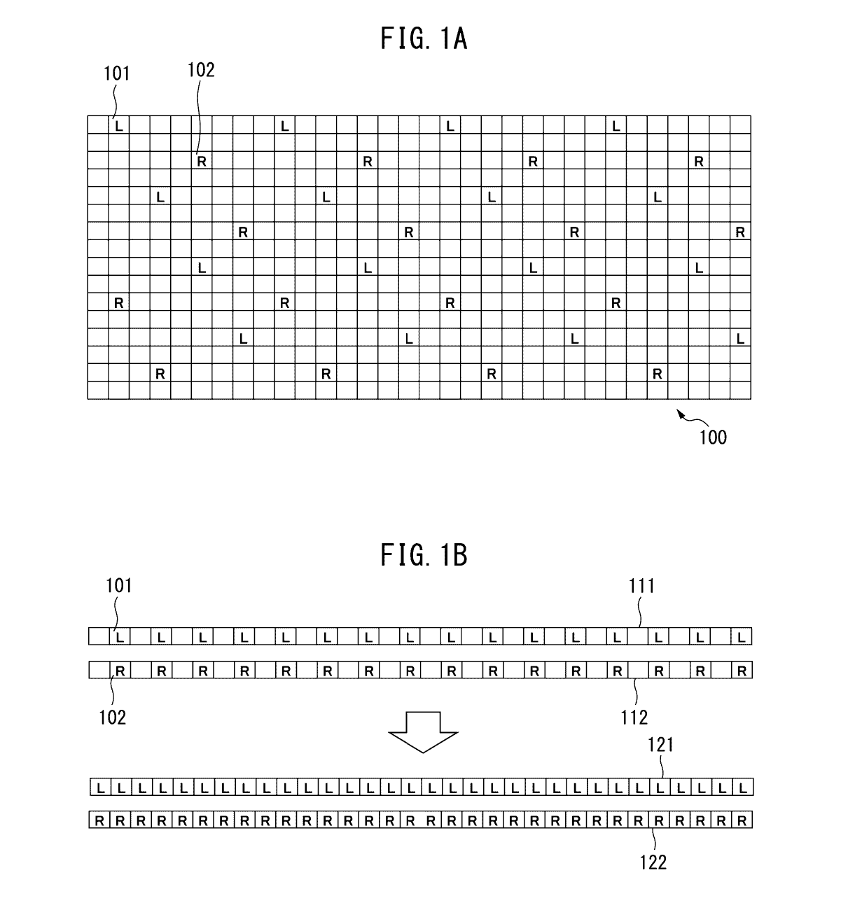

FIG. 1A is a diagram illustrating one example of the arrangement of the left pixels and right pixels in the AF area. In FIG. 1A, each left pixel 101 is designated by “L” and each right pixel 102 by “R” in the AF area 100. As illustrated in FIG. 1A, the left pixels 101 are arranged in a spaced apart manner so as not to be adjacent to each other in order to prevent the quality of the image generated by an image capturing unit from being degraded by the left pixels. Similarly, the right pixels 102 are also arranged in a spaced apart manner so as not to be adjacent to each other.

FIG. 1B is a diagram illustrating the relationship between the arrangement of the left pixels and right pixels illustrated in FIG. 1A and the left image and right image, respectively. When the pixel values of the left pixels 101 in the AF area 100 illustrated in FIG. 1A are projected in the vertical direction, a pixel row 111 is generated in which the pixel values of the left pixels 101 are arranged in a spaced apart manner in a row. Then, by applying interpolation to the pixel row 111 to determine the pixel value of each pixel where there is no left pixel projected, the left image 121 is generated. Similarly, when the pixel values of the right pixels 102 in the AF area 100 are projected in the vertical direction, a pixel row 112 is generated in which the pixel values of the right pixels 102 are arranged in a spaced apart manner in a row. Then, by applying interpolation to the pixel row 112 to determine the pixel value of each pixel where there is no right pixel projected, the right image 122 is generated.

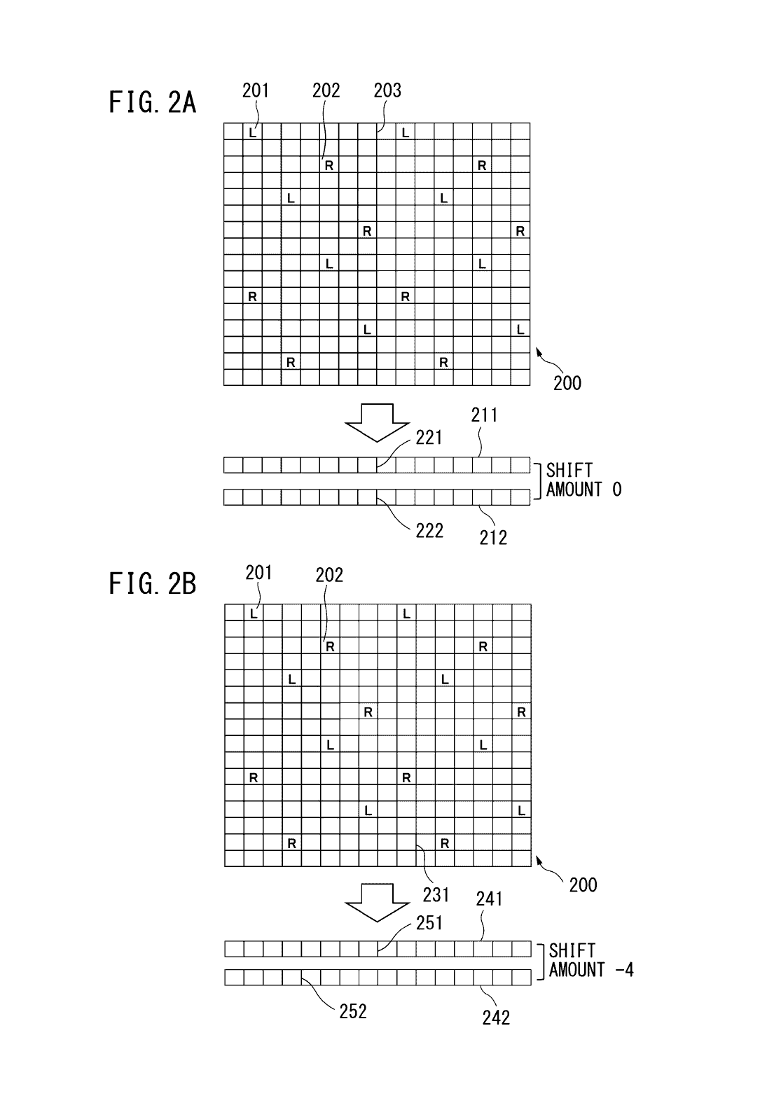

FIG. 2A is a diagram illustrating one example of the left and right images produced when a subject having a vertical edge is captured in an AF area 200 in which the left pixels and right pixels are arranged in the same pattern as the AF area 100 of FIG. 1A. In this example, it is assumed that the image capturing unit is perfectly focused on the subject. Further, in this example, the edge 203 of the subject extends in the vertical direction, which is different from the direction in which the left pixels 201 and right pixels 202 are arranged. Furthermore, the position of the edge 221 in the left image 211 is the same as the position of the edge 222 in the right image 212, and therefore, the shift amount between the left image and the right image is 0. In other words, in this example, the shift amount is accurately obtained.

On the other hand, FIG. 2B is a diagram illustrating one example of the left and right images produced when a subject having an edge parallel to the direction in which the left pixels 201 and right pixels 202 are arranged is captured in the AF area 200. In this example also, it is assumed that the image capturing unit is perfectly focused on the subject. In this example, the edge 231 of the subject extends parallel to the direction in which the left pixels 201 and right pixels 202 are arranged. Then, the position of the edge 251 in the left image 241 is shifted to the right by four pixels with respect to the position of the edge 252 in the right image 242. However, since the image capturing unit is perfectly focused on the subject, the shift amount should normally be 0. This means that the shift amount obtained in this example contains an error of four pixels.

Next, a description will be given of how the measurement accuracy of the shift amount may be degraded depending on the relationship between the arrangement of the left pixels and right pixels and the edge direction of the subject.

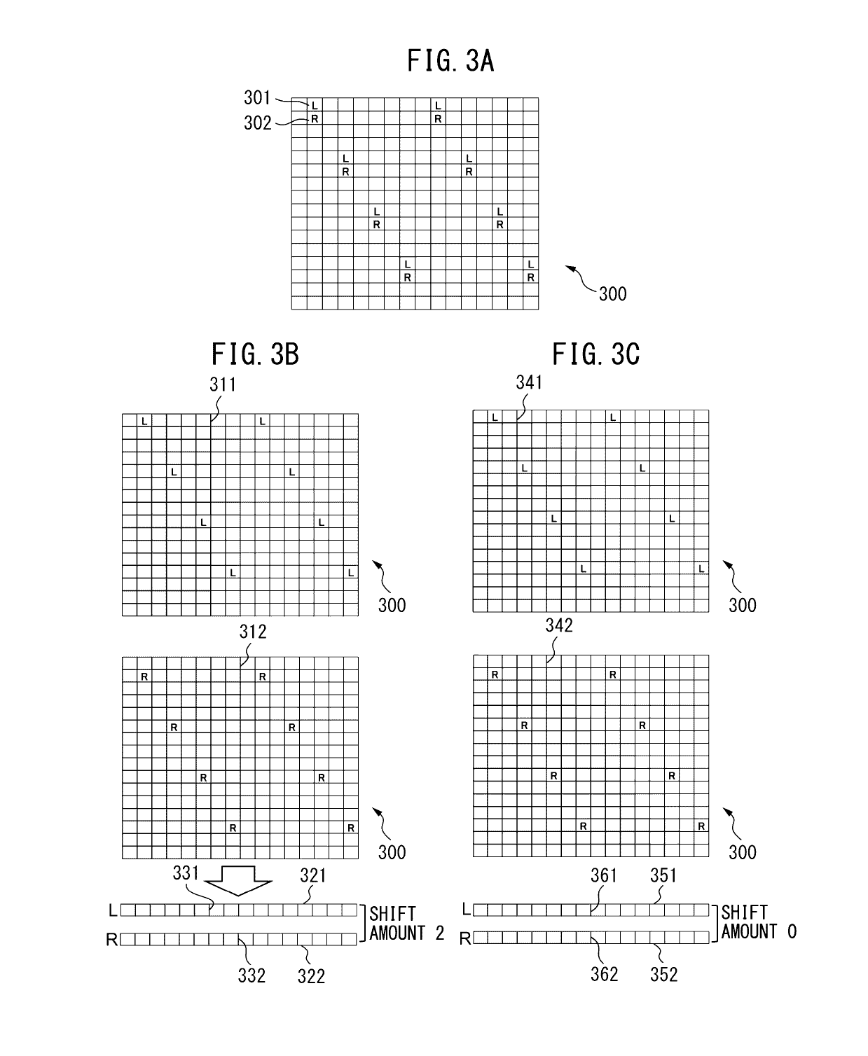

FIG. 3A is a diagram illustrating another example of the arrangement of the left pixels and right pixels in the AF area. In this example, the left pixels 301 and the right pixels 302 are respectively arranged in a spaced apart manner in the AF area 300, but the horizontal positioning of the left pixels 301 is the same as that of the right pixels 302.

FIG. 3B illustrates the relationship between the left image and the right image when the subject captured in the AF area 300 has a vertical edge and when the left image is shifted to the left by two pixels with respect to the right image. In this example, in the AF area 300, the edge 311 of the image of the subject represented by the left image is shifted two pixels to the left with respect to the edge 312 of the image of the subject represented by the right image. In the left image 321 also, the edge 331 contained therein is shifted two pixels to the left with respect to the edge 332 in the right image 322. In other words, in this example, the shift amount is accurately obtained.

FIG. 3C illustrates the relationship between the left image and the right image when the subject captured in the AF area 300 has an edge parallel to the direction in which the left pixels and right pixels are arranged and when the left image is shifted to the left by two pixels with respect to the right image. In the AF area 300, the edge 341 of the image of the subject represented by the left image is shifted two pixels to the left with respect to the edge 342 of the image of the subject represented by the right image, but the position of the edge 361 in the left image 351 is the same as the position of the edge 362 in the right image 352. However, the shift amount should normally be 2. This means that the shift amount obtained in this example contains an error of two pixels.

It will be explained how an error can occur in the measurement of the shift amount depending on the edge direction of the subject, as in the above example.

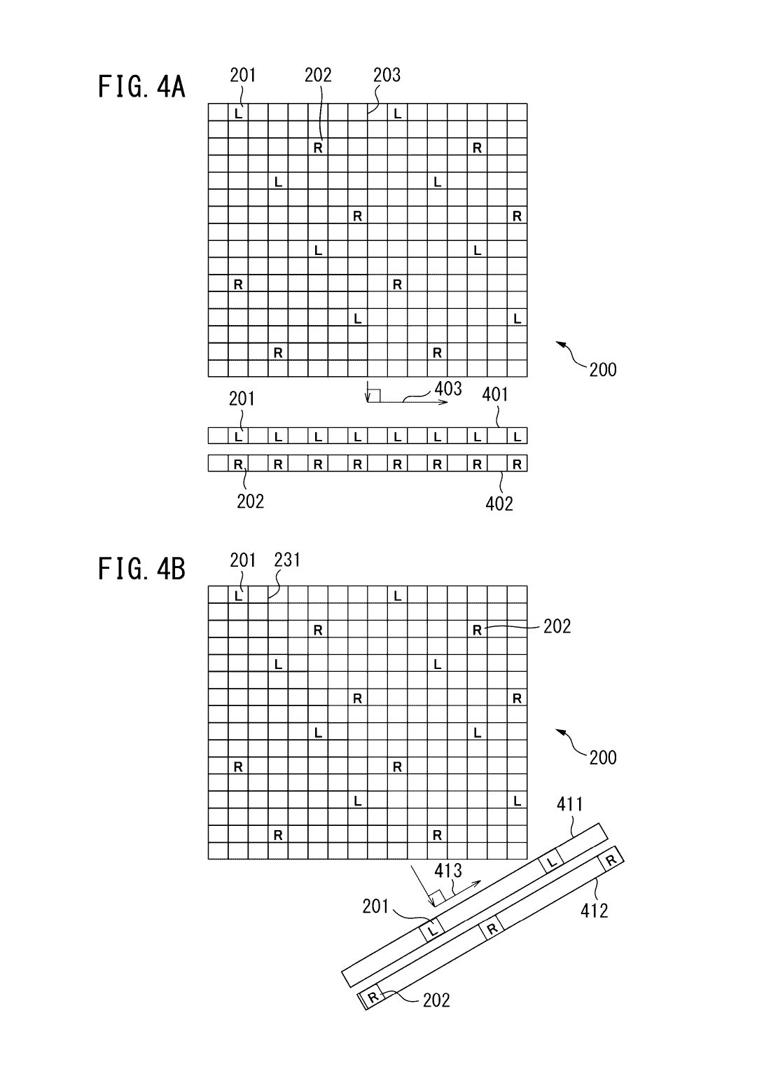

FIG. 4A illustrates the distribution of left pixels and the distribution of right pixels when the left pixels 201 and right pixels 202 in the AF area 200 of FIG. 2A are respectively projected along the direction of the edge 203. On the other hand, FIG. 4B illustrates the distribution of left pixels and the distribution of right pixels when the left pixels 201 and right pixels 202 in the AF area 200 of FIG. 2B are respectively projected along the direction of the edge 231.

As illustrated in FIG. 4A, when the edge direction of the subject is vertical, the position of each left pixel 201 in the projected left pixel row 401 is the same as the position of the corresponding right pixel 202 in the projected right pixel row 402, as viewed in a direction 403 orthogonal to the direction of the edge 203. On the other hand, as illustrated in FIG. 4B, when the edge direction of the subject is parallel to the direction in which the left pixels and right pixels are arranged, the position of each left pixel 201 in the projected left pixel row 411 is shifted with respect to the position of the corresponding right pixel 202 in the projected right pixel row 412, as viewed in a direction 413 orthogonal to the direction of the edge 231. It can therefore be seen that when the left pixels and right pixels are respectively projected along the edge direction of the subject, the positional displacement occurring between the left and right pixels in the direction orthogonal to the edge is one cause for the measurement error of the shift amount.

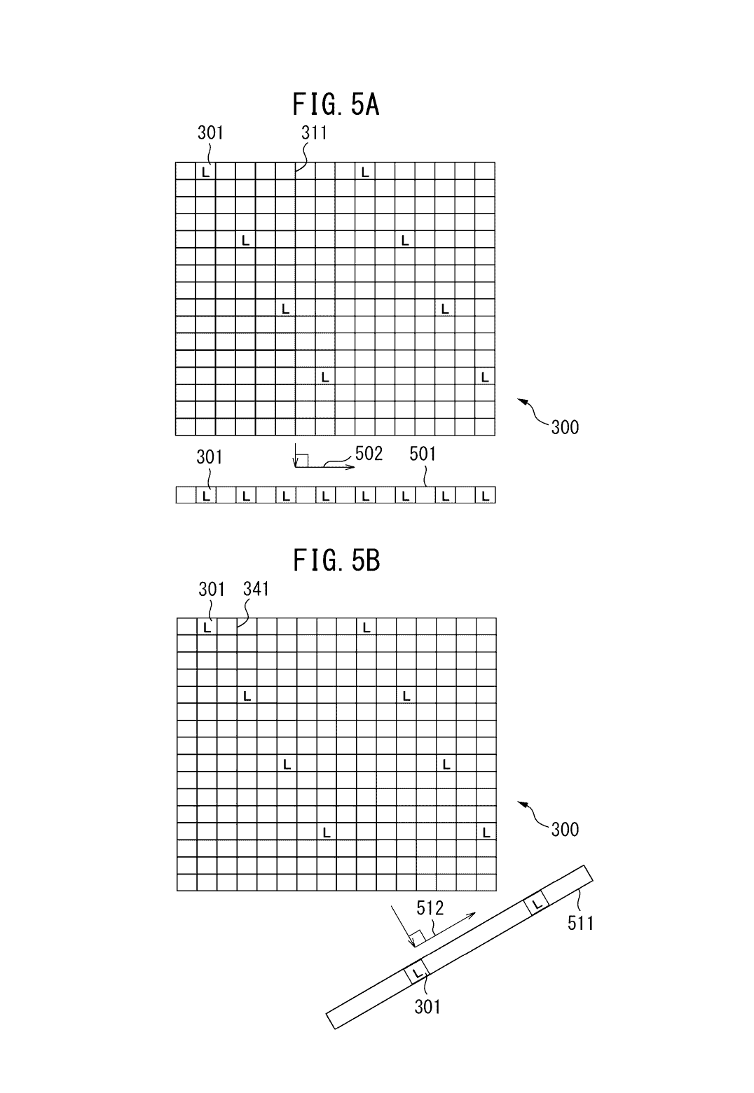

FIG. 5A illustrates the distribution of left pixels when the left pixels 301 in the AF area 300 of FIG. 3B are projected along the direction of the edge 311. On the other hand, FIG. 5B illustrates the distribution of left pixels when the left pixels 301 in the AF area 300 of FIG. 3C are projected along the direction of the edge 341.

As illustrated in FIG. 5A, when the edge direction of the subject is vertical, the left pixels 301 are arranged relatively densely in a direction 502 orthogonal to the edge 311 in the projected pixel row 501, i.e., the left pixels are arranged at closely spaced intervals. On the other hand, as illustrated in FIG. 5B, when the edge direction of the subject is parallel to the direction in which the left pixels and right pixels are arranged, the left pixels 301 are arranged relatively sparsely in a direction 512 orthogonal to the edge 341 in the projected pixel row 511, i.e., the left pixels are arranged at widely spaced intervals. Then, since the position of the edge 341 in the direction orthogonal to the edge 341 is located between the two adjacent left pixels, it is not possible to accurately obtain the position of the edge 341. It can therefore be seen that when the left pixels and right pixels are respectively projected along the edge direction of the subject, the spacing between the left pixels and the spacing between the right pixels in the direction orthogonal to the edge are another cause for the measurement error of the shift amount.

In view of the above, in each AF area, the focus position detection device reduces the confidence score of the shift amount between the two images of the subject as the spacing between the left pixels, the spacing between the right pixels, or the amount of positional displacement between the left and right pixels in the direction orthogonal to the edge increases.

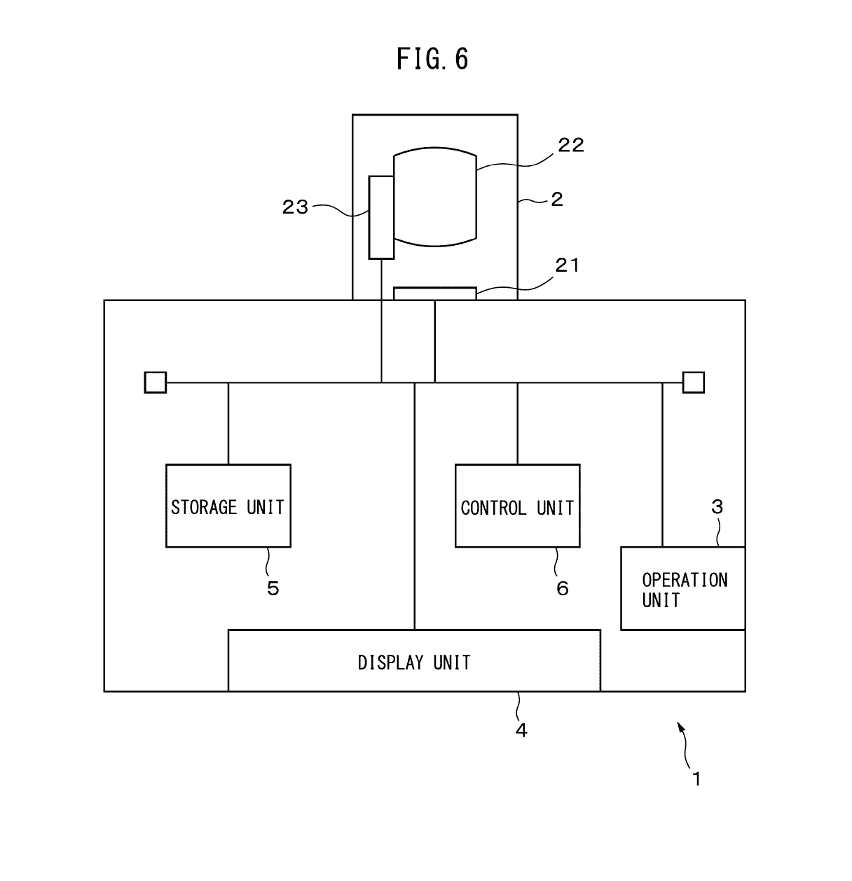

FIG. 6 is a diagram schematically illustrating the configuration of a digital camera as one example of an image capturing apparatus incorporating the focus position detection device. As illustrated in FIG. 6, the digital camera 1 includes an image capturing unit 2, an operation unit 3, a display unit 4, a storage unit 5, and a control unit 6. The digital camera 1 may further include an interface circuit (not depicted), conforming to a serial bus standard such as Universal Serial Bus, for connecting the digital camera 1 to another apparatus such as a computer or a television receiver. The control unit 6 is connected to the other component elements of the digital camera 1, for example, via a bus. The focus position detection device is applicable to various kinds of apparatus having an image capturing unit.

The image capturing unit 2 includes an image sensor 21, an imaging optical system 22, and an actuator 23. The image sensor 21 includes an array of solid-state imaging devices arranged in two dimensions, and is used to generate an image. A light-gathering microlens, for example, is provided in front of each solid-state imaging device. A plurality of AF areas are defined on the image sensor 21. The imaging optical system 22, which is provided on the front side of the image sensor 21, includes, for example, one or more lenses arranged along the optical axis and is actuated to focus an image of a subject onto the image sensor 21. The actuator 23 includes, for example, a stepping motor, and adjusts the focus position by rotating the stepping motor by an amount directed by a control signal from the control unit 6 and thereby moving one or more lenses or the entirety of the imaging optical system 22 along the optical axis. Each time an image containing the subject is generated, the image capturing unit 2 sends the generated image to the control unit 6.

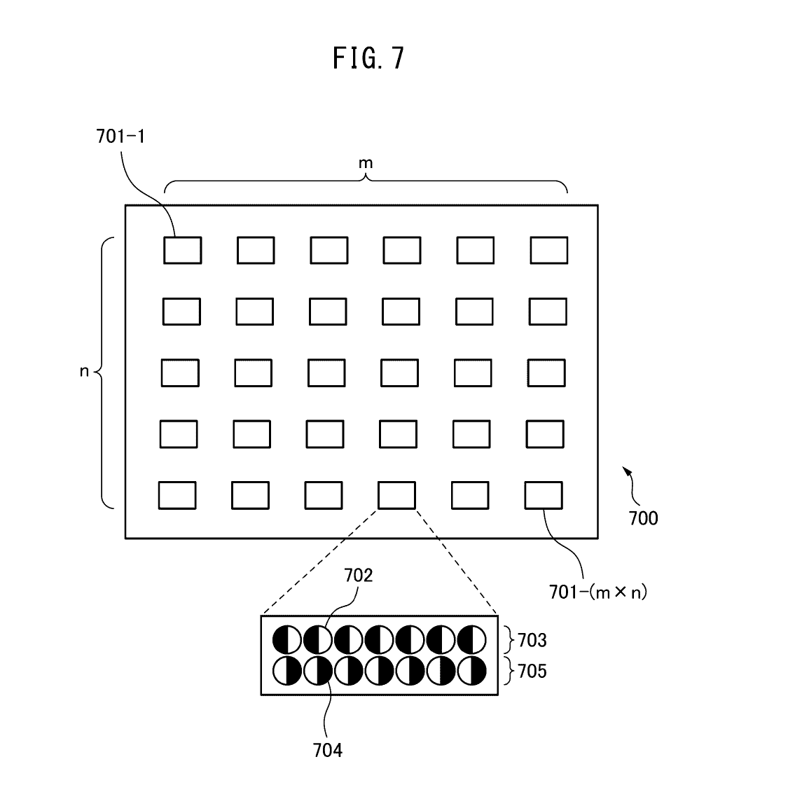

FIG. 7 is a diagram illustrating one example of an arrangement of AF areas defined on the image sensor 21. In this example, AF areas 701-1 to 701-(m×n), in which m is the number of horizontal AF areas and n is the number of vertical AF areas (where m≧1 and n≧1), are provided within an image capturing range 700, i.e., the range within which the image sensor 21 generates images. In each AF area, a left image is generated from a left pixel row 703 formed by arranging a plurality of left pixels 702 horizontally, and a right image is generated from a right pixel row 705 formed by arranging a plurality of right pixels 704 horizontally. In the solid-state imaging devices corresponding to the left pixels, the left half of the light receiving face of each device, for example, is masked. On the other hand, in the solid-state imaging devices corresponding to the right pixels, the right half of the light receiving face of each device, for example, is masked.

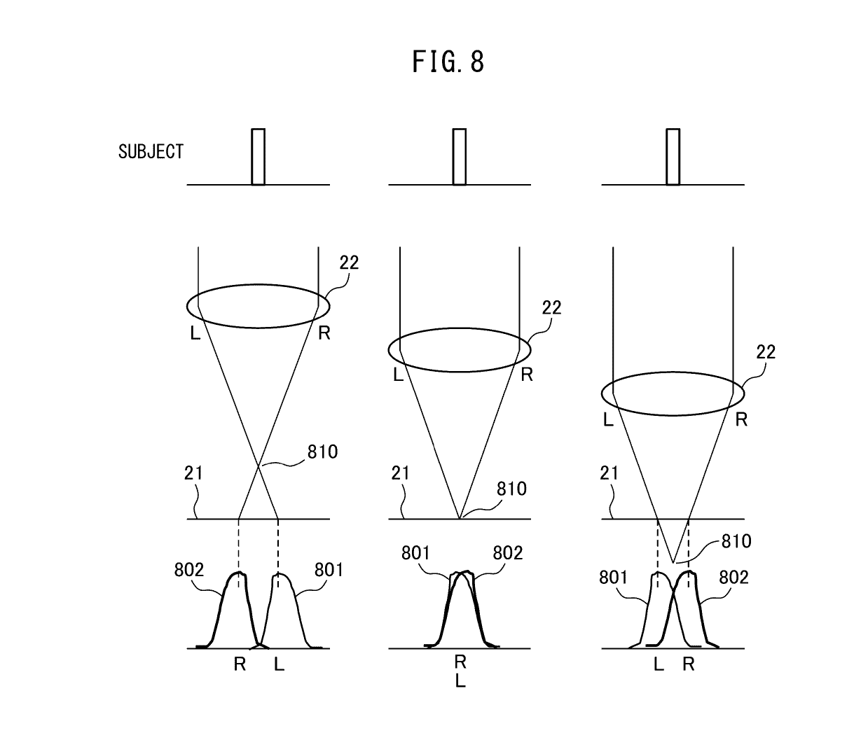

FIG. 8 is a diagram illustrating one example of the left and right images generated from the two pixel rows in the AF area illustrated in FIG. 7. When the focus position 810 achieved by the imaging optical system 22 for the subject captured in the AF area is located on the image sensor 21, the left image 801 generated from the left pixel row 703 and the right image 802 generated from the right pixel row 705 substantially coincide with each other. However, when the focus position 810 achieved by the imaging optical system 22 is located in front of the image sensor 21, i.e., displaced away from it toward the subject, the left image 801 shifts to the right compared with the case where the subject is in focus. On the other hand, the right image 802 shifts to the left compared with the case where the subject is in focus. Conversely, when the focus position 810 achieved by the imaging optical system 22 is located behind the image sensor 21, i.e., displaced away from it toward the direction opposite the subject, the left image 801 shifts to the left compared with the case where the subject is in focus. On the other hand, the right image 802 shifts to the right compared with the case where the subject is in focus. Accordingly, when the degree of coincidence between the left image 801 and the right image 802 is examined by horizontally shifting one of the images relative to the other, it is seen that the shift amount when the highest degree of coincidence is achieved represents the amount of positional displacement of the image sensor 21 from the focus position. Therefore, by moving the imaging optical system 22 so that the shift amount is 0, the control unit 6 can cause the image capturing unit 2 to focus on the subject.

The operation unit 3 includes, for example, various kinds of operation buttons or dial switches for the user to operate the digital camera 1. Then, in response to a user operation, the operation unit 3 sends a control signal for starting the shooting, focusing, or other action, or a setup signal for setting up the shutter speed, aperture opening, etc., to the control unit 6.

Further, the operation unit 3, in response to a user operation, sends information indicating an area in which to detect the focus position of the image capturing unit 2 within the image capturing range (for convenience, the area will hereinafter be referred to as the measurement area) to the control unit 6. A plurality of such measurement areas may be set in advance, for example, in the center, the upper left, and the lower right of the image capturing range or over the entire image capturing range, and the user may select one of the measurement areas by operating the operation unit 3. Alternatively, the measurement area may be set in any desired position within the image capturing range.

The display unit 4 includes, for example, a display device such as a liquid crystal display device, and displays various kinds of information received from the control unit 6 or images generated by the image capturing unit 2. The operation unit 3 and the display unit 4 may be combined into one unit using, for example, a touch panel display.

The storage unit 5 includes, for example, a readable/writable volatile or nonvolatile semiconductor memory circuit. The storage unit 5 stores images received from the image capturing unit 2. The storage unit 5 also stores various kinds of data to be used by the control unit 6 for focus position detection. The various kinds of data stored in the storage unit 5 include, for example, information indicating the position and range of each AF area (for example, the coordinates of the upper left edge and lower right edge of the AF area in the image generated by the image capturing unit 2) and its identification information. Further, the storage unit 5 stores a focal point table to be used for adjustment of the focal point of the imaging optical system 22. The focal point table stores the relationship between the shift amount corresponding to the distance from the image capturing unit 2 to the subject when the imaging optical system 22 is in its reference position and the amount of rotation of the stepping motor corresponding to the amount by which the imaging optical system 22 is to be moved in order to cause the imaging optical system 22 to focus on the subject located at the distance. The reference position of the imaging optical system 22 corresponds, for example, to the position of the imaging optical system 22 when the imaging optical system 22 is focused at infinity. Further, when the functions of the control unit 6 are implemented by a computer program executed on a processor incorporated in the control unit 6, the storage unit 5 may also store such a computer program.

The control unit 6 is one example of the focus position detection device, and includes at least one processor and its peripheral circuitry. The control unit 6 controls the entire operation of the digital camera 1. Further, the control unit 6 detects the focus position based on the image received from the image capturing unit 2, and adjusts the focus position of the imaging optical system 22 based on the detected focus position.

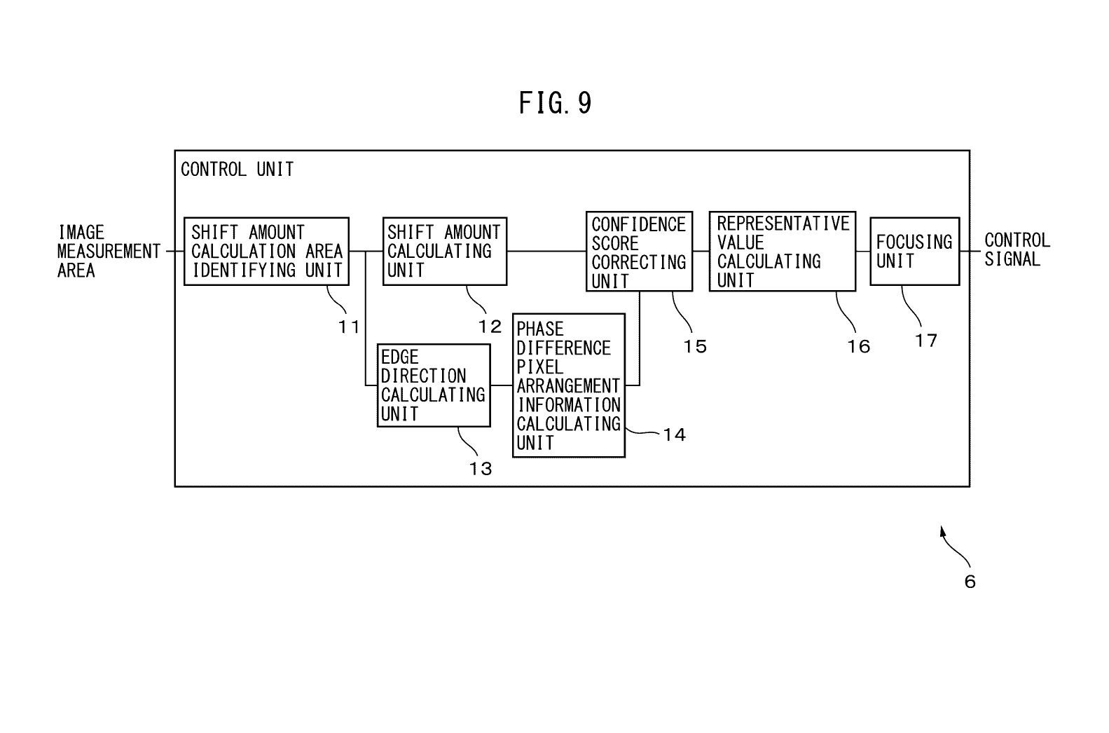

FIG. 9 is a functional block diagram of the control unit 6, illustrating the functions related to the focus position detection and focus position adjustment. The control unit 6 includes a shift amount calculation area identifying unit 11, a shift amount calculating unit 12, an edge direction calculating unit 13, a phase difference pixel arrangement information calculating unit 14, a confidence score correcting unit 15, a representative value calculating unit 16, and a focusing unit 17. These units constituting the control unit 6 are implemented, for example, as functional modules by a computer program executed on a processor incorporated in the control unit 6. Alternatively, one or a plurality of integrated circuits implementing the functions of the various units constituting the control unit 6 may be mounted in the digital camera 1 separately from the control unit 6.

The shift amount calculation area identifying unit 11 identifies AF areas contained in the measurement area selected or set by the user on the image sensor 21 as shift amount calculation areas. First, the shift amount calculation area identifying unit 11 retrieves information indicating the position and range of each AF area from the storage unit 5. Then, by referring to the information indicating the position and range of the AF area, the shift amount calculation area identifying unit 11 identifies the AF area as a shift amount calculation area when the AF area at least partially overlaps the measurement area. Alternatively, the shift amount calculation area identifying unit 11 may identify the AF area as a shift amount calculation area only when the AF area is completely contained in the measurement area.

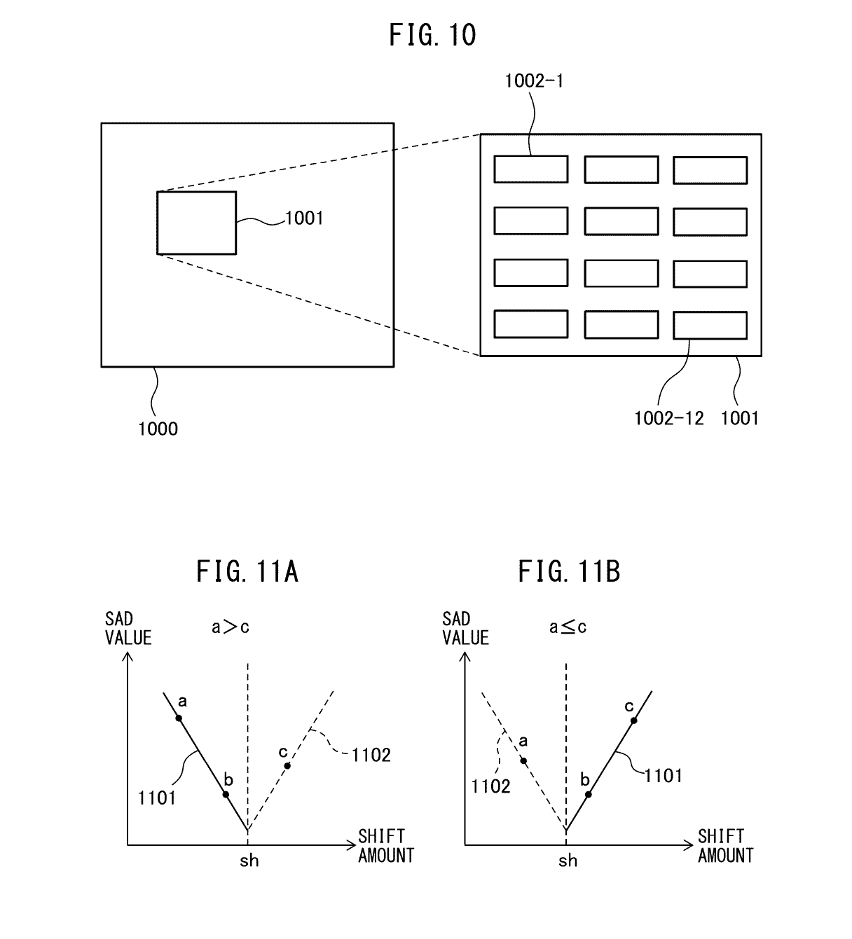

FIG. 10 is a diagram illustrating one example of the relationship between the measurement area and the shift amount calculation areas. In this example, twelve AF areas 1002-1 to 1002-12 are contained in the measurement area 1001 defined within an image capturing range 1000, i.e., the range within which the image sensor 21 forms an image. Accordingly, each of the AF areas 1002-1 to 1002-12 is identified as a shift amount calculation area.

The shift amount calculation area identifying unit 11 provides the identification information of each AF area identified as a shift amount calculation area to the shift amount calculating unit 12 and the edge direction calculating unit 13.

The shift amount calculating unit 12 calculates the shift amount where the left image and the right image best coincide with each other and the confidence score that represents the degree of certainty of the shift amount, for each of the shift amount calculation areas identified by the AF area identification information provided from the shift amount calculation area identifying unit 11.

First, a description will be given of how the shift amount where the left image and the right image best coincide with each other (for convenience, hereinafter referred to as the local shift amount) is calculated for each shift amount calculation area.

The shift amount calculating unit 12 calculates the sum of the absolute differences (SAD) between the pixel values of corresponding pixels by shifting, for example, the position of the right image relative to the left image on a pixel by pixel basis. Then, the shift amount calculating unit 12 can take as the local shift amount the shift amount of the right image relative to the left image when the SAD value is minimum.

For each shift amount calculation area, the shift amount calculating unit 12 can calculate the SAD(s) for the shift amounts, for example, in accordance with the following equation.

$$SAD [ s ] = {\sum }_{n = 0}^{N - 1} \vert R [ n + s + S ] - L [ n + s ] \vert ( - S ≦ s ≦ S ) \qquad ( 1 )$$

where N represents the number of pixels in the left and right images used in one SAD computation. On the other hand, +S to −S represents the shift amount range that serves as the search range for the local shift amount. Further, L[n] and R[n] represent the pixel values of the nth pixels in the left and right images, respectively.

In equation (1), the local shift amount is calculated on a pixel by pixel basis. However, in actuality, the local shift amount that minimizes the SAD value may not necessarily be found on a pixel by pixel basis. In view of this, the shift amount calculating unit 12 obtains the local shift amount on a subpixel by subpixel basis by equiangular linear fitting, using the shift amount that minimizes the SAD value in equation (1) and the SAD values for the shift amounts in the neighborhood thereof.

FIGS. 11A and 11B are diagrams illustrating the principle of equiangular linear fitting. In FIGS. 11A and 11B, the abscissa represents the shift amount, and the ordinate represents the SAD value. Further, b indicates the minimum value of SAD calculated by equation (1), a indicates the SAD value when the shift amount is smaller by one pixel than the shift amount corresponding to the minimum value of SAD, and c indicates the SAD value when the shift amount is larger by one pixel than the shift amount corresponding to the minimum value of SAD. In equiangular linear fitting, it is assumed that the slope of increase of the SAD value when the shift amount decreases from the local shift amount is equal to the slope of increase of the SAD value when the shift amount increases.

In view of this, a straight line 1101 is obtained which passes through a point corresponding to the minimum value b of SAD and its adjacent point a or c, whichever is larger in SAD value; i.e., of straight lines ab and bc, the straight line whose slope is larger in terms of absolute value is obtained as the straight line 1101. As illustrated in FIG. 11A, when a> c, the straight line ab is obtained as the straight line 1101; on the other hand, as illustrated in FIG. 11B, when a c, the straight line bc is obtained as the straight line 1101. Further, a straight line 1102 is obtained which passes through a or c, whichever is smaller in SAD value, and which has a slope opposite to that of the straight line 1101 (i.e., the sign of the slope is opposite). Then, the shift amount corresponding to the point of intersection of the straight lines 1101 and 1102 is taken as the shift amount representing the local shift amount sh on a subpixel by subpixel basis.

The shift amount calculating unit 12 can calculate the local shift amount sh by equiangular linear fitting in accordance with the following equation.

$$sh = \{ \begin{matrix}{s}_{min} + 0.5 \times ( c - a ) / ( b - a ) & ( when a > c ) \\ {s}_{min} + 0.5 \times ( c - a ) / ( b - c ) & ( when a \leq c )\end{matrix} \qquad ( 2 )$$

where sₘᵢₙ represents the shift amount on a pixel by pixel basis that minimizes the SAD value. Further, a=SAD[sₘᵢₙ−1], b=SAD[sₘᵢₙ], and c=SAD[sₘᵢₙ+1]. The local shift amount sh on a subpixel by subpixel basis will hereinafter be referred to simply as the local shift amount.

It is anticipated that the local shift amount calculated as described above will have a relatively accurate value, provided that neither the values of the left pixels in the left pixel row forming the left image nor the values of the right pixels in the right pixel row forming the right image contain any noise component. However, when the subject is dark, for example, the extent to which noise components contribute to the values of the left pixels or right pixels increases. In such cases, an accurate value may not necessarily be obtained as the local shift amount.

Therefore, the shift amount calculating unit 12 calculates a confidence score representing the degree of certainty of the local shift amount for each shift amount calculation area.

In the present embodiment, the shift amount calculating unit 12 calculates an estimate of the variance of the local shift amount as the confidence score. Generally, the smaller the variance of the local shift amount is, the more likely it is that the local shift amount has an accurate value. For convenience, the variance of the local shift amount will hereinafter be referred to as the estimated variance.

When the contrast of the subject represented by the left and right images is constant, the minimum value of SAD is larger and the variation in the local shift amount increases as the amount of noise component superimposed on the pixels contained in the left pixel row or right pixel row increases. On the other hand, when the minimum value of SAD is constant, i.e., when the amount of noise component superimposed on the pixels contained in the left pixel row or right pixel row is constant, the variation in the local shift amount decreases as the contrast of the subject represented by the left and right images increases. In view of this, the shift amount calculating unit 12 calculates the estimated value of the variance of the local shift amount, based on the ratio of the minimum value of SAD to the contrast of the left or right image.

The shift amount calculating unit 12 calculates the ratio R of the minimum value of SAD to the contrast of subject represented by the left or right image in accordance with the following equation.

$$R = \frac{{SAD}_{min}}{C} \qquad ( 3 )$$

where SADₘᵢₙ is the smallest of the SAD values calculated in accordance with equation (1), and C is the contrast value. The contrast value C is calculated, for example, as the difference (Pₘₐₓ−Pₘᵢₙ) between the maximum value Pₘₐₓ among the values of the pixels contained in the left and right images and the minimum value Pₘᵢₙ among the values of the pixels contained in the left and right images. The contrast value C may alternatively be calculated as (Pₘₐₓ−Pₘᵢₙ)/(Pₘₐₓ Pₘᵢₙ). Further, Pmax and Pmin may be the maximum and minimum values, respectively, of the pixels taken from either one of the left and right images.

By referring, for example, to a mapping table defining the relationship between the ratio R and the estimated variance, the shift amount calculating unit 12 can obtain the confidence score, i.e., the value of the estimated variance corresponding to the ratio R calculated in accordance with equation (3). The mapping table is constructed, for example, by obtaining the variation in the local shift amount with respect to the ratio R, through experiment or simulation, by variously changing the amount of noise superimposed on the pixel values using test patterns of the left and right images whose local shift amount and contrast are known. The mapping table is stored in advance in the storage unit 5.

According to a modified example, the shift amount calculating unit 12 may calculate as the confidence score the expected value of the absolute value of the error of the local shift amount. In this case, a mapping table that defines the relationship between the ratio R and the expected value of the absolute value of the error of the local shift amount is constructed and stored in advance in the storage unit 5 and, by referring to this table, the shift amount calculating unit 12 obtains the expected value of the absolute value of the error of the local shift amount corresponding to the ratio R.

According to another modified example, the shift amount calculating unit 12 may calculate as the confidence score the probability that the error between the calculated local shift amount and the actual shift amount, i.e., the true shift amount, falls within a predetermined value (for example, three pixels). In this case, a mapping table that defines the relationship between the ratio R and the probability that the error falls within the predetermined value is constructed and stored in advance in the storage unit 5 and, by referring to this table, the shift amount calculating unit 12 obtains the probability corresponding to the ratio R.

Alternatively, the shift amount calculating unit 12 may take the ratio R calculated in accordance with equation (3) directly as the confidence score.

The shift amount calculating unit 12 supplies the local shift amount calculated for each shift amount calculation area to the representative value calculating unit 16 and the confidence score calculated for each shift amount calculation area to the confidence score correcting unit 15.

The edge direction calculating unit 13 calculates the edge direction of the subject in each shift amount calculation area. Since the edge direction calculating unit 13 performs the same processing for all the shift amount calculation areas, the processing performed to calculate the edge direction in one particular shift amount calculation area will be described below.

As earlier described, there are cases where the left and right pixels used for the calculation of the local shift amount are arranged in a spaced apart manner in the shift amount calculation area. Therefore, the edge direction calculating unit 13 calculates the edge direction of the subject by using, for example, the values of imaging pixels that are contained in the shift amount calculation area but not included in the left and right pixels used for the calculation of the local shift amount.

In this case, the edge direction calculating unit 13 generates an interpolated image by applying interpolation, such as nearest neighbor interpolation, bilinear interpolation, or bicubic interpolation, and interpolating the values of left and right pixels in the shift amount calculation area by using the values of the pixels in the neighborhood thereof. Then, the edge direction calculating unit 13 obtains the edge direction based on the interpolated image. If it is not possible to acquire the values of imaging pixels, but it is only possible to use the values of the left and right pixels, then the edge direction calculating unit 13 may interpolate the value of each pixel by using the left or right pixels located to the left and right of that pixel. In this way, the edge direction calculating unit 13 may generate an interpolated image with left or right pixels arranged horizontally and vertically at regularly spaced intervals in a lattice-like pattern.

The edge direction calculating unit 13 performs processing for edge direction detection on the interpolated image in the shift amount calculation area, for example, by applying an edge detection filter, such as a Sobel filter, that provides an edge intensity value proportional to the edge direction.

For example, the edge direction calculating unit 13 calculates the edge intensity in the horizontal direction and the edge intensity in the vertical direction by applying Sobel filtering for calculating the edge intensity in the horizontal direction and Sobel filtering for calculating the edge intensity in the vertical direction to the pixels in the interpolated image. In this case, when the pixel located at position (x,y) on the interpolated image is designated by f(x,y), the edge intensity in the vertical direction, Sv(x,y), and the edge intensity in the horizontal direction, Sh(x,y), can be expressed as:

Sv(x,y)=(f(x−1,y−1)+2f(x−1,y)+f(x−1,y+1)−f(x+1,y−1)−2f(x+1,y)−f(x+1,y+1)/4

Sh(x,y)=(f(x−1,y−1)+2f(x,y−1)+f(x+1,y−1)−f(x−1,y+1)−2f(x,y+1)−f(x+1,y+1))/4 (4)

Further, for each pixel in the interpolated image, the edge direction calculating unit 13 calculates the edge intensity St(x,y) and the edge direction θ(x,y) in that pixel in accordance with the following equations.

$$St ( x , y ) = \sqrt{{Sh ( x , y )}^{2} + {Sv ( x , y )}^{2}} \\ θ ( x , y ) = arctan ( \frac{Sv ( x , y )}{Sh ( x , y )} ) \qquad ( 5 )$$

The edge direction calculating unit 13 obtains a histogram of edge directions θ(x,y) by calculating the sum of edge intensities St(x,y) for each edge direction θ(x,y) over the entire interpolated image. Then, the edge direction calculating unit 13 determines that the direction having the highest frequency in the histogram of edge directions θ(x,y) represents the edge direction of the subject in the shift amount calculation area.

Alternatively, the edge direction calculating unit 13 may obtain the edge detection of the subject in each shift amount calculation area by applying one of various other edge direction calculation methods for detecting the edge direction of a subject contained in an image.

The edge direction calculating unit 13 notifies the phase difference pixel arrangement information calculating unit 14 of the edge direction of the subject detected in each shift amount calculation area.

For each shift amount calculation area, the phase difference pixel arrangement information calculating unit 14 calculates the spacing between the left pixels, the spacing between the right pixels, and the amount of positional displacement between the left and right pixels as measured along the direction orthogonal to the edge direction of the subject detected in the shift amount calculation area. Since the phase difference pixel arrangement information calculating unit 14 performs the same processing for all the shift amount calculation areas, the processing performed for one particular shift amount calculation area will be described below.

To calculate the spacing between the left pixels, the spacing between the right pixels, and the amount of positional displacement between the left and right pixels, the phase difference pixel arrangement information calculating unit 14 projects the left pixels and right pixels in the shift amount calculation area along the edge direction of the subject detected in the shift amount calculation area.

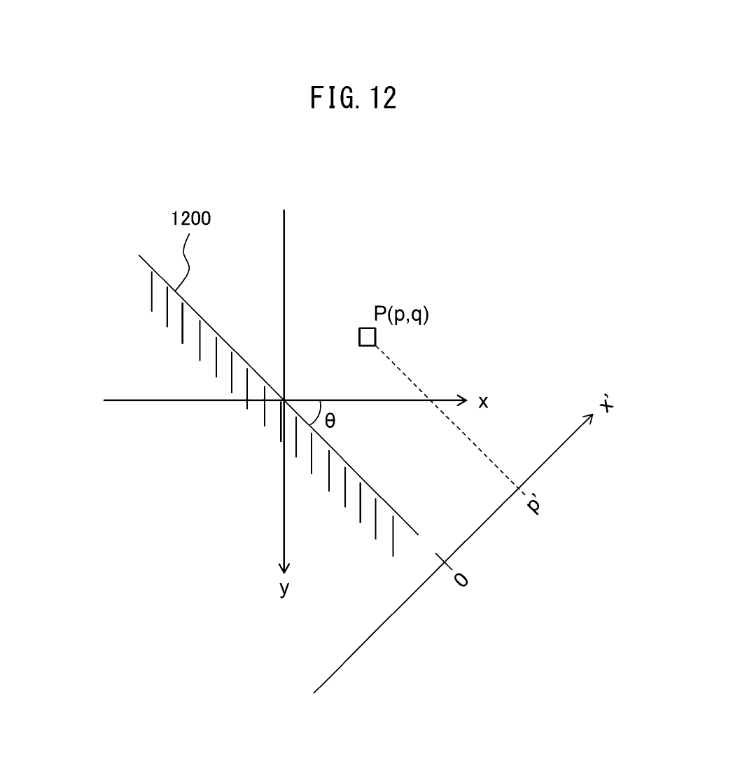

FIG. 12 is a diagram for explaining how a pixel is projected along the edge direction. In FIG. 12, the x-axis direction indicates the horizontal direction of the shift amount calculation area, and the y-axis direction indicates the vertical direction of the shift amount calculation area. Further, a line 1200 indicates the edge direction, and the x′-axis direction indicates the direction orthogonal to the edge direction. As a result, θ represents the angle between the horizontal direction and the edge direction. In this case, when the pixel P(p,q) located at position (p,q) is projected onto the x′ axis along the edge direction 1200, the projected coordinate of the pixel P(p,q) in the direction orthogonal to the edge direction, i.e., the coordinate p′ on the x′ axis, is expressed as:

p′=p sin θ−q cos θ (6)

Therefore, for each of the left and right pixels contained in the shift amount calculation area, the phase difference pixel arrangement information calculating unit 14 calculates the coordinate in the direction orthogonal to the edge direction in accordance with equation (6).

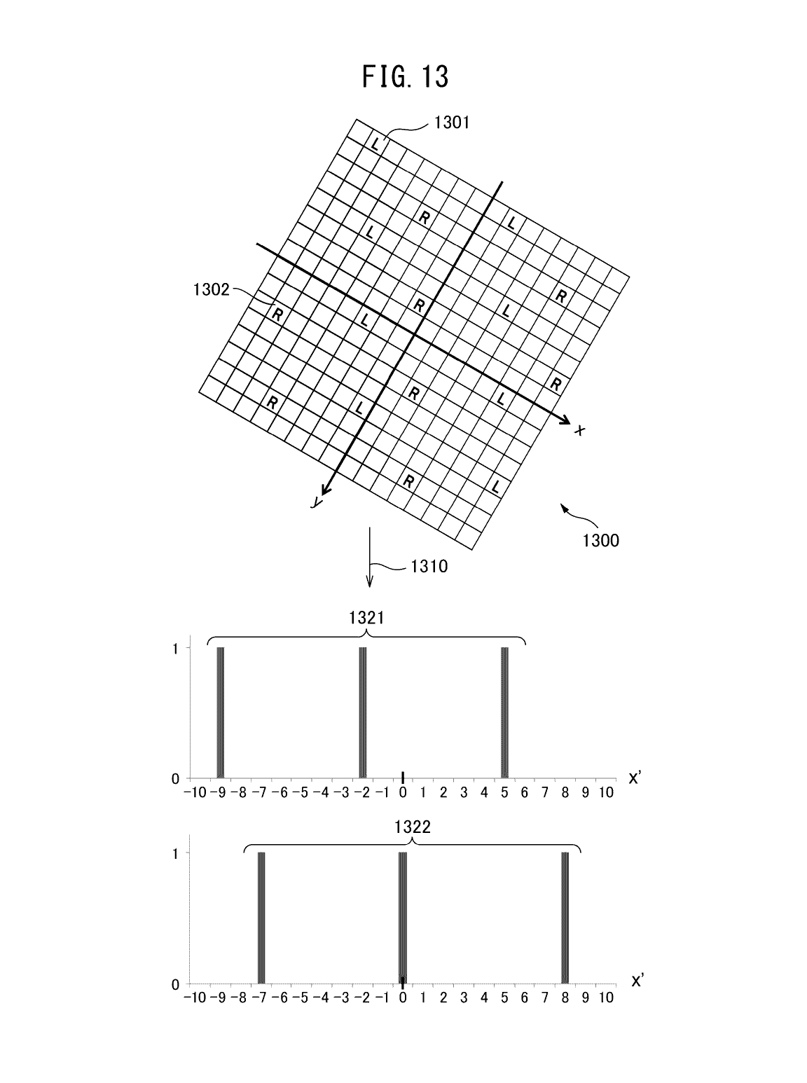

FIG. 13 is a diagram illustrating by way of example the arrangement of the left and right pixels, the edge direction, and the distribution of the projected left and right pixels. In FIG. 13, each left pixel 1301 contained in the shift amount calculation area 1300 is designated by L, and each right pixel 1302 by R. The x-axis direction indicates the horizontal direction of the shift amount calculation area, and the y-axis direction indicates the vertical direction of the shift amount calculation area. In this example, the edge is formed along the direction indicated by an arrow 1310. Accordingly, when the left pixels 1301 are projected along the edge direction 1310, the distribution of the left pixels, 1321, in the direction orthogonal to the edge direction 1310 is obtained. In the distribution 1321, the horizontal axis represents the coordinate in the direction orthogonal to the edge direction, and the vertical axis indicates the presence or absence of a left pixel; the number “1” indicates that there is one or more left pixels, while the number “0” indicates that there is no left pixel. Similarly, when the right pixels 1302 are projected along the edge direction 1310, the distribution of the right pixels, 1322, in the direction orthogonal to the edge direction 1310 is obtained. In the distribution 1322, the horizontal axis represents the coordinate in the direction orthogonal to the edge direction, and the vertical axis indicates the presence or absence of a right pixel; the number “1” indicates that there is one or more right pixels, while the number “0” indicates that there is no left pixel. In this example, the spacing between the left pixels and the spacing between the right pixels, as measured in the direction orthogonal to the edge direction, are each equal to seven pixels.

Based on the projected positions of the left pixels in the direction orthogonal to the edge direction, the phase difference pixel arrangement information calculating unit 14 calculates the spacing between the left pixels in the direction orthogonal to the edge direction. Similarly, based on the projected positions of the right pixels in the direction orthogonal to the edge direction, the phase difference pixel arrangement information calculating unit 14 calculates the spacing between the right pixels in the direction orthogonal to the edge direction. Since the phase difference pixel arrangement information calculating unit 14 performs the same processing for the calculation of the spacing between the right pixels as for the calculation of the spacing between the left pixels, the calculation of the spacing between the left pixels will be described below.

As illustrated in FIG. 13, when the spacing between any two left pixels after projection is the same, the phase difference pixel arrangement information calculating unit 14 takes the spacing directly as the spacing between the left pixels in the direction orthogonal to the edge direction. However, there are cases where the spacing between two adjacent left pixels differs depending on the position in the direction orthogonal to the edge direction.

For example, suppose that the spacing between two adjacent left pixels at a given position is 8 while the spacing between two left pixels adjacent to them is 2. In this case, if the value ((8+2)/2=5) obtained by simply taking an average between the two spacings were taken to represent the spacing between the left pixels, a better value would be obtained as the spacing between the left pixels, due to the smaller spacing (2), than the resolution that could actually be achieved by the arrangement of the left pixels. This is apparent if one considers the fact that the pixel arrangement in which the left pixels are arranged at equally spaced intervals of five pixels can achieve a better resolution than the pixel arrangement in which the spacing between the left pixels alternates between 8 and 2, because the maximum pixel spacing is smaller in the former than in the latter.

In view of the above, the phase difference pixel arrangement information calculating unit 14, for example, calculates the spacing between left pixels, dL, in accordance with the following equation.

$$dL = \frac{{\sum }_{j} {P}_{j}^{2}}{{\sum }_{j} {P}_{j}} \qquad ( 7 )$$

where pⱼ is the spacing between two adjacent left pixels, and Σₚⱼ represents the sum of the spacings each taken between two adjacent left pixels contained in a section in which the spacing between each pair of adjacent left pixels is repeated in a specific pattern. In other words, the spacing between left pixels, dL, represents the expected value of the spacing between the left pixels at a given pixel position contained in the section in which the spacing between each pair of adjacent left pixels is repeated in a specific pattern.

For example, when the spacing between each pair of adjacent left pixels alternates between 8 and 2, as described above, the length of the section in which the spacing between each pair of adjacent left pixels is repeated in a specific pattern is 10. In this case, the probability of a given pixel being contained in the first spacing (8) is calculated as 0.8 (=8/(8+2)). Similarly, the probability of the given pixel being contained in the second spacing (2) is calculated as 0.2 (=2/(8+2)). Eight pixels are contained in the first spacing, and two pixels in the second spacing. Accordingly, the expected value of the pixel spacing at the given pixel position is given as 0.8×8+0.2×2=6.8, as indicated in equation (7).

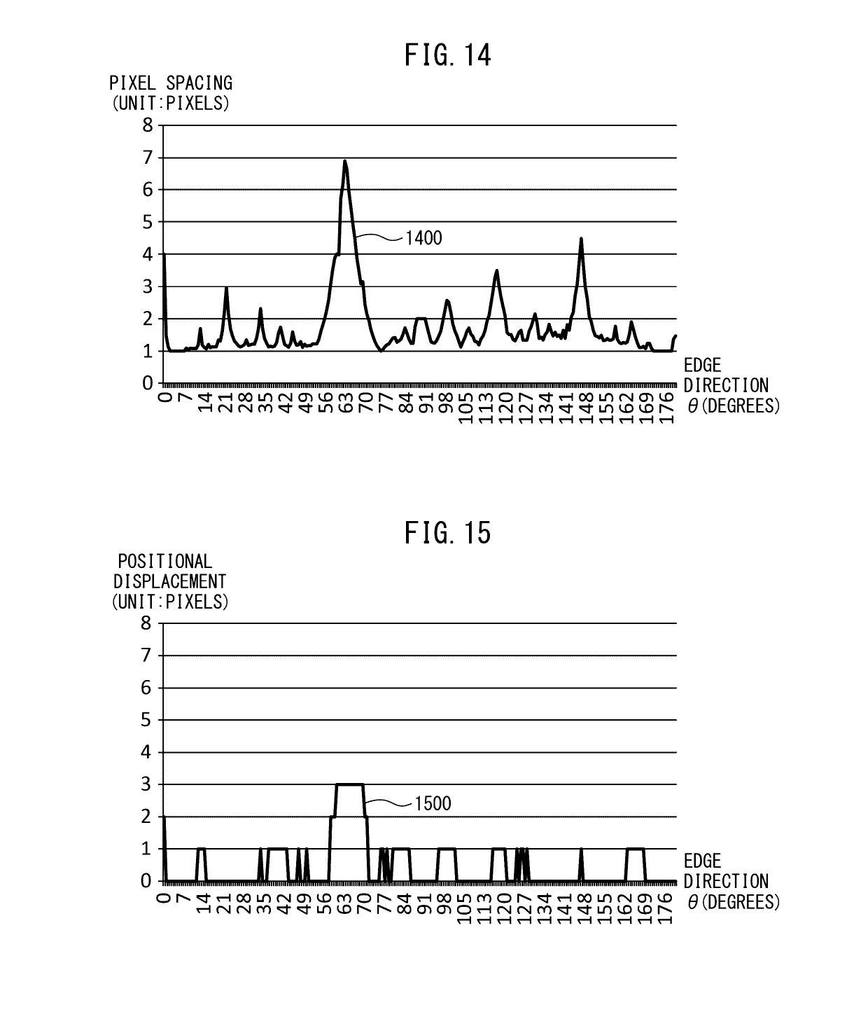

FIG. 14 is a graph plotting the spacing between left pixels as a function of the edge direction for the arrangement of the left pixels depicted in FIG. 13. In FIG. 14, the horizontal axis represents the edge direction θ, and the vertical axis represents the spacing between left pixels. The distribution 1400 depicts the spacing between left pixels as a function of the edge direction θ. As can be seen from the distribution 1400, the spacing between left pixels is the largest when the edge direction is 63°. This is because a plurality of left pixels is projected on the same direction as viewed in the direction orthogonal to the edge direction. As a result, in the case of a subject having such an edge direction, the resolution of the left image is low, and therefore, the measurement accuracy of the local shift amount is also low. On the other hand, when the edge direction is, for example, 77°, the spacing between left pixels is approximately 1. As a result, in the case of a subject having such an edge direction, the resolution of the left image is high, and therefore, the measurement accuracy of the local shift amount is relatively high.

Based on the distributions of the projected left pixels and right pixels along the direction orthogonal to the edge direction, the phase difference pixel arrangement information calculating unit 14 calculates the amount of positional displacement between the left and right pixels along the direction orthogonal to the edge direction.

For example, the phase difference pixel arrangement information calculating unit 14 calculates the projected distribution of the left pixels by setting the value for each coordinate position taken along the direction orthogonal to the edge direction such that when one or more left pixels are projected, the value is set to “1” but, when no left pixels are projected, the value is set to “0”, as indicated by the distribution 1321 in FIG. 13. Similarly, the phase difference pixel arrangement information calculating unit 14 calculates the projected distribution of the right pixels by setting the value for each coordinate position taken along the direction orthogonal to the edge direction such that when one or more right pixels are projected, the value is set to “1” but, when no right pixels are projected, the value is set to “0”. Then, the phase difference pixel arrangement information calculating unit 14 calculates the SAD value between the projected distribution of the left pixels and the projected distribution of the right pixels, for example, by variously changing the relative position between the projected distribution of the left pixels and the projected distribution of the right pixels, as described in connection with equation (1). The phase difference pixel arrangement information calculating unit 14 then determines that the amount of positional displacement that minimizes the SAD value represents the amount of positional displacement between the left and right pixels in the direction orthogonal to the edge direction.

When at least one of the projected distribution of the left pixels and the projected distribution of the right pixels is a periodically varying distribution, the amount of positional displacement that minimizes the SAD value appears in accordance with the period. In this case, the phase difference pixel arrangement information calculating unit 14 may determine that the smallest of the amounts of positional displacement that minimize the SAD value represents the amount of positional displacement between the left and right pixels in the direction orthogonal to the edge direction.

FIG. 15 is a graph plotting the amount of positional displacement between the left and right pixels as a function of the edge direction for the arrangement of the left and right pixels depicted in FIG. 13. In FIG. 15, the horizontal axis represents the edge direction θ, and the vertical axis represents the amount of positional displacement. The distribution 1500 depicts the amount of positional displacement between the left and right pixels as a function of the edge direction θ. As can be seen from the distribution 1500, the amount of positional displacement between the left and right pixels is the largest (three pixels) when the edge direction is 63°. Accordingly, for such an edge direction, the measurement accuracy of the local shift amount is relatively low. On the other hand, when the edge direction is 90°, the amount of positional displacement between the left and right pixels is the smallest (0 pixel). Accordingly, for such an edge direction, the measurement accuracy of the local shift amount is relatively high.

The phase difference pixel arrangement information calculating unit 14 thus calculates the spacing between the left pixels, the spacing between the right pixels, and the amount of positional displacement between the left and right pixels in the direction orthogonal to the edge direction for each shift amount calculation area, and supplies the results of the calculations to the confidence score correcting unit 15.

For each shift amount calculation area, the confidence score correcting unit 15 corrects the confidence score of the local shift amount in the shift amount calculation area, based on the spacing between the left pixels, the spacing between the right pixels, and the amount of positional displacement between the left and right pixels calculated for that shift amount calculation area. Since the confidence score correcting unit 15 performs the same processing for all the shift amount calculation areas, the processing performed for one particular shift amount calculation area will be described below.

In the present embodiment, the confidence score correcting unit 15 corrects the confidence score so that the degree of certainty of the local shift amount represented by the confidence score decreases as the spacing between the left pixels, the spacing between the right pixels, or the amount of positional displacement between the left and right pixels increases. For this purpose, the confidence score correcting unit 15 compares the confidence score with a predetermined reference confidence score which is selected based on the spacing between the left pixels, the spacing between the right pixels, and the amount of positional displacement between the left and right pixels calculated for each shift amount calculation area. When the degree of certainty of the local shift amount represented by the confidence score is higher than the degree of certainty of the local shift amount represented by the reference confidence score, the confidence score correcting unit 15 replaces the confidence score by the reference confidence score. For example, when the confidence score is expressed in terms of the estimated variance, the expected value of the absolute value of the error of the local shift amount, or the ratio of the minimum value of SAD to the contrast, the value of the confidence score is smaller as the degree of certainty of the local shift amount is higher. In this case, when the reliability score is smaller than the reference reliability score, the confidence score correcting unit 15 replaces the reliability score by the reference reliability score; on the other hand, when the reliability score is not smaller than the reference reliability score, the reliability score is not changed. On the other hand, when the reliability score is expressed in terms of the probability that the error between the local shift amount and the true shift amount falls below a predetermined value, the value of the confidence score is larger as the degree of certainty of the local shift amount is higher. In this case, when the reliability score is larger than the reference reliability score, the confidence score correcting unit 15 replaces the reliability score by the reference reliability score; on the other hand, when the reliability score is not larger than the reference reliability score, the reliability score is not changed. In this way, the confidence score correcting unit 15 can correct the reliability score to a value that accounts for the degree of uncertainty associated with the relationship between the edge direction and the arrangement of the left and right pixels.

The reference confidence score is precalculated and prestored in the storage unit 5, for example, as described below. Using a plurality of test patterns generated by variously changing the position of the edge and the amount of defocus of the edge (which corresponds to the true shift amount between the left and right images), the local shift amount is calculated for each test pattern and for each set of the spacing between the left pixels, the spacing between the right pixels, and the amount of positional displacement between the left and right pixels. When the confidence score is expressed in terms of the estimated variance, the reference confidence score is calculated as the variance of the error between the local shift amount calculated for each test pattern and the true shift amount. Similarly, when the confidence score is expressed in terms of the expected value of the absolute value of the error between the local shift amount and the true shift amount, the reference confidence score is calculated as the expected value of the absolute value of the error between the local shift amount calculated for each test pattern and the true shift amount. On the other hand, when the confidence score is expressed in terms of the ratio of the minimum value of SAD to the contrast or the probability that the error between the local shift amount and the true shift amount falls below a predetermined value, the reference confidence score is calculated as the expected value of the ratio or probability calculated for each test pattern.

When the confidence score is expressed in terms of the estimated variance, the expected value of the absolute value of the error between the local shift amount and the true shift amount, or the ratio of the minimum value of SAD to the contrast, the reference confidence score necessarily is larger as the spacing between the left pixels, the spacing between the right pixels, or the amount of positional displacement between the left and right pixels is larger. On the other hand, when the confidence score is expressed in terms of the probability that the error between the local shift amount and the true shift amount falls below a predetermined value, the reference confidence score necessarily is smaller as the spacing between the left pixels, the spacing between the right pixels, or the amount of positional displacement between the left and right pixels is larger. As a result, the value of the confidence score is corrected so that the degree of certainty of the local shift amount represented by the confidence score does not is higher than the degree of certainty of the local shift amount represented by the reference confidence score. The confidence score correcting unit 15 can thus make a correction so that the possibility that the measurement accuracy of the local shift amount decreases due to the relationship between the edge direction and the arrangement of the left and right pixels can be appropriately reflected in the confidence score.

According to a modified example, the confidence score correcting unit 15 calculates a first ratio of the spacing between the left pixels to the maximum value of the spacing between the left pixels or the spacing between the right pixels for which the correction of the confidence score is not needed, and a second ratio of the spacing between the right pixels to that maximum value. Further, the confidence score correcting unit 15 calculates a third ratio of the amount of positional displacement between the left and right images to the maximum value of the amount of positional displacement between the left and right images for which the correction of the confidence score is not needed. Then, the confidence score correcting unit 15 chooses the largest of the three ratios as a correction coefficient. When the confidence score is expressed in terms of the estimated variance, the expected value of the absolute value of the error between the local shift amount and the true shift amount, or the ratio of the minimum value of SAD to the contrast, then the confidence score correcting unit 15 calculates the corrected confidence score by multiplying the confidence score by the correction coefficient. On the other hand, when the confidence score is expressed in terms of the probability that the error between the local shift amount and the true shift amount falls below a predetermined value, the confidence score correcting unit 15 calculates the corrected confidence score by dividing the confidence score by the correction coefficient.

The confidence score correcting unit 15 supplies the corrected confidence score calculated for each shift amount calculation area to the representative value calculating unit 16.

Then, based on the local shift amount and the corrected confidence score for each shift amount calculation area contained in the measurement area, the representative value calculating unit 16 calculates a representative shift amount representing the focus position of the subject captured in the shift amount calculation area.

The representative value calculating unit 16 calculates the representative shift amount S for the measurement area, for example, by taking a weighted average of the local shift amounts of the respective shift amount calculation areas with weighting based on their confidence scores, in accordance with the following equation.

$$S = \frac{{\sum }_{i = 1}^{N} {S}_{i} / {V}_{i}}{{\sum }_{i = 1}^{N} 1 / {V}_{i}} \qquad ( 8 )$$

where Sᵢ is the local shift amount for the ith shift amount calculation area, and Vᵢ is the confidence score of the ith shift amount calculation area. N represents the number of shift amount calculation areas contained in the measurement area. However, equation (8) is applied to the case in which the value of the confidence score Vᵢ is smaller as the degree of certainty of the local shift amount Sᵢ is higher, such as when the estimated variance is calculated as the confidence score. Accordingly, as can be seen from equation (8), the higher the degree of certainty of the local shift amount Sᵢ, the greater is the contribution of the shift amount calculation area to the representative shift amount. Rather than using equation (8), the representative value calculating unit 16 may calculate the representative shift amount S by taking an average or median of the local shift amounts over the shift amount calculation areas none of whose confidence scores reach a predetermined threshold, or of a predetermined number of local shift amounts selected in increasing order of confidence score starting from the smallest one. In this case also, the higher the degree of certainty of the local shift amount Sᵢ, the greater is the contribution of the shift amount calculation area to the representative shift amount. Further, when the value of the confidence score Vᵢ is larger as the degree of certainty of the local shift amount Sᵢ is higher, such as when the probability that the error of the local shift amount falls below a predetermined value is calculated as the confidence score, the representative value calculating unit 16 may calculate the representative shift amount S, for example, in accordance with the following equation.

$$S = \frac{{\sum }_{i = 1}^{N} ( {S}_{i} \cdot {V}_{i} )}{{\sum }_{i = 1}^{N} {V}_{i}} \qquad ( 9 )$$

In this case also, rather than using equation (9), the representative value calculating unit 16 may calculate the representative shift amount S by taking an average or median of the local shift amounts over the shift amount calculation areas none of whose confidence scores fall short of a predetermined threshold, or of a predetermined number of local shift amounts selected in decreasing order of confidence score starting from the largest one.

Further, when the focusing unit 17 uses a contrast detection method in combination with the intended method, as will be described later, the representative value calculating unit 16 may calculate the estimated variance of the representative shift value (hereinafter referred to as the representative variance) V. For example, when the value of the confidence score is smaller as the degree of certainty of the local shift amount is higher, as when the confidence score is calculated as the estimated variance, the representative value calculating unit 16 calculates the representative variance V in accordance with the following equation.

$$V = \frac{{\sum }_{i = 1}^{N} {( 1 / {V}_{i} )}^{2} {V}_{i}}{{\sum }_{i = 1}^{N} {( 1 / {V}_{i} )}^{2 }} = \frac{{\sum }_{i = 1}^{N} 1 / {V}_{i}}{{\sum }_{i = 1}^{N} {( 1 / {V}_{i} )}^{2 }} \qquad ( 10 )$$

Since the control unit 6 can cause the image capturing unit 2 to focus on the subject captured in the measurement area by moving the imaging optical system 22 along the optical axis by an amount equal to the representative shift amount, the representative shift amount represents the focus position. The representative value calculating unit 16 supplies the representative shift amount to the focusing unit 17. When the focusing unit 17 uses a contrast detection method in combination with the intended method, as will be described later, the representative value calculating unit 16 supplies the representative variance to the focusing unit 17 as well.

The focusing unit 17 refers to a focus table to obtain the amount of rotation of the stepping motor corresponding to the amount of movement of the image capturing unit 2 that corresponds to the representative shift amount. Then, the focusing unit 17 supplies a control signal to the actuator 23 which in response rotates the stepping motor in the actuator 23 of the image capturing unit 2 by an amount equal to the obtained amount of rotation minus the amount of rotation corresponding to the difference between the current position of the image capturing unit 2 and its reference position. By thus rotating the stepping motor by the amount of rotation indicated by the control signal, the actuator 23 moves the imaging optical system 22 along the optical axis so as to reduce the representative shift amount to 0. In this way, the image capturing unit 2 can be focused onto the subject captured in the measurement area.

According to a modified example, the focusing unit 17 may cause the image capturing unit 2 to focus on the subject captured in the measurement area by using a contrast detection method in combination with the phase difference detection method. In this case, first the focusing unit 17 causes the stepping motor to rotate by the amount of rotation corresponding to the representative shift amount and thus causes the imaging optical system 22 to move along the optical axis so as to reduce the representative shift amount to 0. Then, based on the representative variance received from the representative value calculating unit 16, the focusing unit 17 sets the range of the position of the imaging optical system 22 within which to examine the contrast of the subject. More specifically, the focusing unit 17 sets the range of the position of the imaging optical system 22 within which to examine the contrast of the subject, for example, as a range equivalent to ±two times the standard deviation corresponding to the representative variance. Then, while moving the imaging optical system 22 within the range, the focusing unit 17 detects the position of the imaging optical system 22 that maximizes the contrast within the range corresponding to the measurement area defined on the image obtained by the image capturing unit 2. The focusing unit 17 then determines that the position of the imaging optical system 22 that maximizes the contrast represents the position at which the imaging optical system 22 is focused on the subject captured in the measurement area. When the position that maximizes the contrast is not found within the thus set position range of the imaging optical system 22, the focusing unit 17 may search outside the range to find the position of the imaging optical system 22 that maximizes the contrast.

As described above, even when using the contrast detection method in combination with the phase difference detection method, the focusing unit 17 can appropriately limit the range of the position of the imaging optical system 22 within which to examine the contrast by the contrast detection method. This serves to reduce the time that the focusing unit 17 takes to cause the image capturing unit 2 to focus on the subject captured within the measurement area.

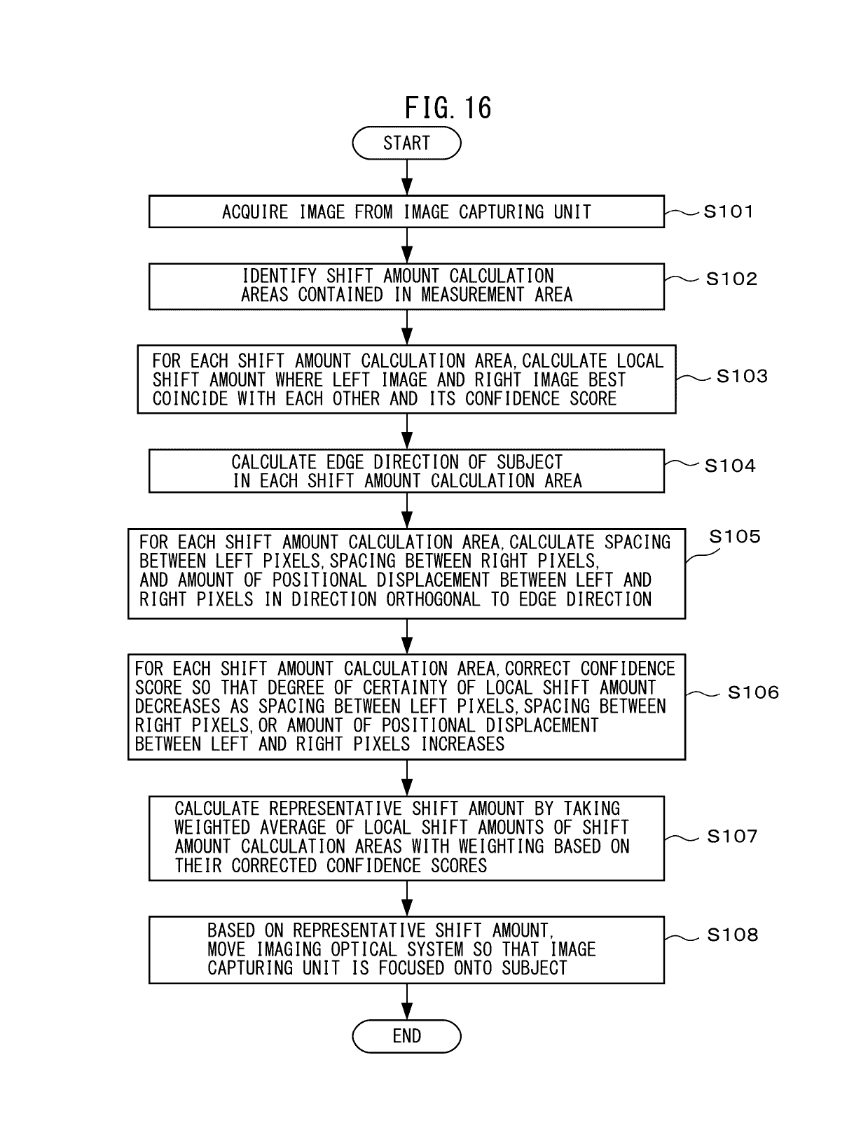

FIG. 16 is an operation flowchart of a focus position detection process performed by the control unit 6.

The control unit 6 acquires an image captured of a subject from the image capturing unit 2 (step S101). Then, the control unit 6 stores the image in the storage unit 5.

The shift amount calculation area identifying unit 11 identifies the shift amount calculation areas contained in the specified measurement area (step S102). Then, the shift amount calculation area identifying unit 11 notifies the shift amount calculating unit 12 and the edge direction calculating unit 13 of the identified shift amount calculation areas.

Based on the image stored in the storage unit 5, the shift amount calculating unit 12 calculates, for each shift amount calculation area, the local shift amount where the left image and the right image best coincide with each other and its confidence score (step S103). Then, the shift amount calculating unit 12 supplies the local shift amount calculated for each shift amount calculation area to the representative value calculating unit 16 and the confidence score to the confidence score correcting unit 15.

For each shift amount calculation area, the edge direction calculating unit 13 calculates the edge direction of the subject in the shift amount calculation area (step S104). Then, the edge direction calculating unit 13 supplies the edge direction of the subject calculated for each shift amount calculation area to the phase difference pixel arrangement information calculating unit 14.

For each shift amount calculation area, the phase difference pixel arrangement information calculating unit 14 calculates the spacing between left pixels, the spacing between right pixels, and the amount of positional displacement between the left and right pixels in the direction orthogonal to the edge direction in the shift amount calculation area (step S105). The phase difference pixel arrangement information calculating unit 14 supplies the spacing between left pixels, the spacing between right pixels, and the amount of positional displacement between the left and right pixels calculated for each shift amount calculation area to the confidence score correcting unit 15.

For each shift amount calculation area, the confidence score correcting unit 15 corrects the confidence score so that the degree of certainty of the local shift amount represented by the confidence score decreases as the spacing between left pixels, the spacing between right pixels, or the amount of positional displacement between the left and right pixels in the shift amount calculation area increases (step S106). Then, the confidence score correcting unit 15 supplies the corrected confidence score for each shift amount calculation area to the representative value calculating unit 16.

The representative value calculating unit 16 calculates the representative shift amount for the entire measurement area by taking a weighted average of the local shift amounts of the respective shift amount calculation areas with weighting based on their corrected confidence scores (step S107). The representative value calculating unit 16 supplies the representative shift amount to the focusing unit 17.

Based on the representative shift amount, the focusing unit 17 causes the imaging optical system 22 in the image capturing unit 2 to move along the optical axis so that the image capturing unit 2 is focused onto the subject captured in the measurement area (step S108). Then, the control unit 6 terminates the focus position detection process.

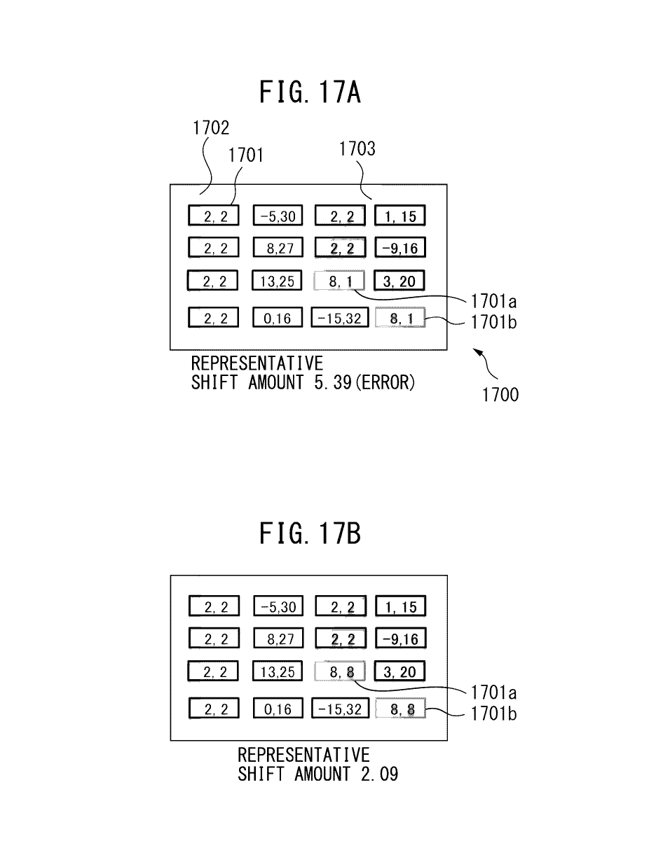

FIG. 17A is a diagram illustrating the local shift amounts in the respective shift amount calculation areas contained in the measurement area and their confidence scores when the confidence scores are not corrected. On the other hand, FIG. 17B is a diagram illustrating the local shift amounts in the respective shift amount calculation areas contained in the measurement area and their confidence scores when the confidence scores are corrected in accordance with the above embodiment or its modified example. In FIGS. 17A and 17B, the shift amount calculation areas 1701, four horizontally and three vertically, are defined within the measurement area 1700. In each shift amount calculation area 1701, the numerical value at the left indicates the local shift amount, and the numerical value at the right indicates the confidence score expressed in terms of the estimated variance. Lines 1702 and 1703 respectively indicate the edges of the subject.

In the shift amount calculation areas that do not contain any edge of the subject, it is difficult to accurately detect the local shift amount where the left image and the right image best coincide with each other; therefore, the local shift amount is given a random value, and the value of the confidence score is very large. As a result, such shift amount calculation areas have negligible effect on the calculation of the representative shift amount. On the other hand, as depicted in FIG. 17A, in the shift amount calculation areas 1701a and 1701b which contain the edge 1703, the edge direction does not match the arrangement of the left and right pixels; therefore, the value of the confidence score is smaller than it would normally be. As a result, the representative shift amount is significantly affected by the local shift amounts in the shift amount calculation areas 1701a and 1701b, and is calculated as 5.39, a value displaced from the correct focus position.

On the other hand, in FIG. 17B, the values of the confidence scores of the shift amount calculation areas 1701a and 1701b are corrected to values larger than those in FIG. 17A by accounting for the relationship between the edge direction and the arrangement of the left and right pixels. As a result, the calculation of the representative shift amount is less affected by the local shift amounts in the shift amount calculation areas 1701a and 1701b, and the representative shift amount is calculated as 2.09, a value close to the correct focus position.

As has been described above, the focus position detection device according to the embodiment corrects the confidence score of the local shift amount in each shift amount calculation area contained in the measurement area in accordance with the spacing between left pixels, the spacing between right pixels, and the amount of positional displacement between the left and right pixels in the direction orthogonal to the edge direction of the subject. Then, the focus position detection device obtains the representative shift amount representing the focus position by taking a weighted average of the local shift amounts of the respective shift amount calculation areas with weighting based on the corrected confidence scores. As a result, the focus position detection device can reduce an error that can occur in the focus position due to a mismatch between the edge direction of the subject captured in each shift amount calculation area and the arrangement of the left and right pixels.

According to a modified example, the phase difference pixel arrangement information calculating unit 14 may calculate only one or two of the spacing between left pixels, the spacing between right pixels, and the amount of positional displacement between the left and right pixels for each shift amount calculation area. The confidence score correcting unit 15 may then correct the confidence score by performing the same processing as above in accordance with the calculated one or ones of the spacing between left pixels, the spacing between right pixels, and the amount of positional displacement between the left and right pixels. In this case, the focus position detection device can enhance the response speed of the image capturing unit 2 for focusing, because the amount of computation taken to correct the confidence score is reduced.

According to another modified example, the focus position detection device may not only be applied to the detection of focus position using the phase difference detection method, but may also be applied for use, for example, in an image capturing apparatus, such as a binocular camera, that obtains two images with parallax for a subject, in order to measure the distance to the subject. In the latter case, a distance table that provides a mapping between the representative shift amount and the distance from the image capturing apparatus to the subject, for example, is stored in advance in a storage unit incorporated in the image capturing apparatus. Then, a control unit incorporated in the image capturing apparatus performs the same processing as that implemented by the functions of the control unit according to the above embodiment on the two parallax images generated by the image capturing apparatus; in this way, the control unit can calculate the representative shift amount for the subject captured in the measurement area defined on each image sensor used to form an image. Then, the control unit can obtain the distance from the image capturing apparatus to the subject captured in the measurement area by referring to the distance table and finding the distance corresponding to the calculated representative shift amount.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A focus position detection device comprising:
a processor configured to:
identify a plurality of shift amount calculation areas contained in a measurement area defined on an image sensor which is used to generate an image and which together with an optical system constitutes an image capturing device, each of the plurality of shift amount calculation areas having a plurality of first pixels for generating a first sub-image representing a subject captured in the shift amount calculation area and a plurality of second pixels for generating a second sub-image representing the subject captured in the shift amount calculation area, wherein a shift amount representing a shift between the subject on the first sub-image and the subject on the second sub-image varies according to a distance between the image sensor and a focus position achieved by the optical system for the subject;
calculate, for each of the plurality of shift amount calculation areas, a local shift amount of the second sub-image relative to the first sub-image when the subject on the first sub-image and the subject on the second sub-image best coincide with each other, and a confidence score representing a degree of certainty of the local shift amount;
correct, for each of the plurality of shift amount calculation areas, the confidence score based on at least one of a spacing between adjacent ones of the plurality of first pixels, a spacing between adjacent ones of the plurality of second pixels, and an amount of positional displacement between the plurality of first pixels and the plurality of second pixels in a direction orthogonal to an edge direction of the subject in the shift amount calculation area; and
calculate a representative value representing the distance between the image sensor and the focus position achieved by the optical system, by taking a weighted average of the local shift amounts of the plurality of shift amount calculation areas with weighting based on the corrected confidence scores.

2. The focus position detection device according to claim 1, wherein the processor is further configured to calculate, for each of the plurality of shift amount calculation areas, the edge direction of the subject in the shift amount calculation area.

3. The focus position detection device according to claim 1, wherein the processor is further configured to calculate, for each of the plurality of shift amount calculation areas, the at least one of the spacing between adjacent first pixels, the spacing between adjacent second pixels, and the amount of positional displacement.

4. The focus position detection device according to claim 1, wherein the correction of the confidence score corrects the confidence score for each of the plurality of shift amount calculation areas so that the degree of certainty of the local shift amount represented by the confidence score of the shift amount calculation area decreases as at least one of the spacing between adjacent first pixels, the spacing between adjacent second pixels, and the amount of positional displacement in the shift amount calculation area increases.

5. The focus position detection device according to claim 4, wherein the correction of the confidence score includes comparing the confidence score of each of the plurality of shift amount calculation areas with a reference confidence score and, when the degree of certainty of the local shift amount represented by the confidence score is higher than the degree of certainty of the local shift amount represented by the reference confidence score, then correcting the confidence score to match the reference confidence score, and wherein the degree of certainty of the local shift amount represented by the reference confidence score decreases as at least one of the spacing between adjacent first pixels, the spacing between adjacent second pixels, and the amount of positional displacement increases.

6. The focus position detection device according to claim 1, wherein the calculation of the confidence score includes calculating, for each of the plurality of shift amount calculation areas, a sum of absolute differences in pixel value between corresponding pixels in the first sub-image and the second sub-image by incrementally shifting the second sub-image relative to the first sub-image in the shift amount calculation area, and calculating the confidence score based on a ratio taken between a minimum value of the sum and a contrast of the subject in the shift amount calculation area.

7. A focus position detection method comprising:
identifying a plurality of shift amount calculation areas contained in a measurement area defined on an image sensor which is used to generate an image and which together with an optical system constitutes an image capturing device, each of the plurality of shift amount calculation areas having a plurality of first pixels for generating a first sub-image representing a subject captured in the shift amount calculation area and a plurality of second pixels for generating a second sub-image representing the subject captured in the shift amount calculation area, wherein a shift amount representing a shift between the subject on the first sub-image and the subject on the second sub-image varies according to a distance between the image sensor and a focus position achieved by the optical system for the subject;
calculating, for each of the plurality of shift amount calculation areas, a local shift amount of the second sub-image relative to the first sub-image when the subject on the first sub-image and the subject on the second sub-image best coincide with each other, and calculating a confidence score representing a degree of certainty of the local shift amount;
correcting, for each of the plurality of shift amount calculation areas, the confidence score based on at least one of a spacing between adjacent ones of the plurality of first pixels, a spacing between adjacent ones of the plurality of second pixels, and an amount of positional displacement between the plurality of first pixels and the plurality of second pixels in a direction orthogonal to an edge direction of the subject in the shift amount calculation area; and
calculating a representative value representing the distance between the image sensor and the focus position achieved by the optical system, by taking a weighted average of the local shift amounts of the plurality of shift amount calculation areas with weighting based on the corrected confidence scores.

8. The focus position detection method according to claim 7, further comprising calculating, for each of the plurality of shift amount calculation areas, the edge direction of the subject in the shift amount calculation area.

9. The focus position detection method according to claim 7, further comprising calculating, for each of the plurality of shift amount calculation areas, the at least one of the spacing between adjacent first pixels, the spacing between adjacent second pixels, and the amount of positional displacement.

10. The focus position detection method according to claim 7, wherein the correction of the confidence score corrects the confidence score for each of the plurality of shift amount calculation areas so that the degree of certainty of the local shift amount represented by the confidence score of the shift amount calculation area decreases as at least one of the spacing between adjacent first pixels, the spacing between adjacent second pixels, and the amount of positional displacement in the shift amount calculation area increases.

11. The focus position detection method according to claim 10, wherein the correction of the confidence score includes comparing the confidence score of each of the plurality of shift amount calculation areas with a reference confidence score and, when the degree of certainty of the local shift amount represented by the confidence score is higher than the degree of certainty of the local shift amount represented by the reference confidence score, then correcting the confidence score to match the reference confidence score, and wherein the degree of certainty of the local shift amount represented by the reference confidence score decreases as at least one of the spacing between adjacent first pixels, the spacing between adjacent second pixels, and the amount of positional displacement increases.

12. The focus position detection method according to claim 7, wherein the calculation of the confidence score includes calculating, for each of the plurality of shift amount calculation areas, a sum of absolute differences in pixel value between corresponding pixels in the first sub-image and the second sub-image by incrementally shifting the second sub-image relative to the first sub-image in the shift amount calculation area, and calculating the confidence score based on a ratio taken between a minimum value of the sum and a contrast of the subject in the shift amount calculation area.

13. A non-transitory computer-readable recording medium having recorded thereon a computer program for focus position detection that causes a computer to execute a process comprising:
identifying a plurality of shift amount calculation areas contained in a measurement area defined on an image sensor which is used to generate an image and which together with an optical system constitutes an image capturing device, each of the plurality of shift amount calculation areas having a plurality of first pixels for generating a first sub-image representing a subject captured in the shift amount calculation area and a plurality of second pixels for generating a second sub-image representing the subject captured in the shift amount calculation area, wherein a shift amount representing a shift between the subject on the first sub-image and the subject on the second sub-image varies according to a distance between the image sensor and a focus position achieved by the optical system for the subject;
calculating, for each of the plurality of shift amount calculation areas, a local shift amount of the second sub-image relative to the first sub-image when the subject on the first sub-image and the subject on the second sub-image best coincide with each other, and calculating a confidence score representing a degree of certainty of the local shift amount;
correcting, for each of the plurality of shift amount calculation areas, the confidence score based on at least one of a spacing between adjacent ones of the plurality of first pixels, a spacing between adjacent ones of the plurality of second pixels, and an amount of positional displacement between the plurality of first pixels and the plurality of second pixels in a direction orthogonal to an edge direction of the subject in the shift amount calculation area; and
calculating a representative value representing the distance between the image sensor and the focus position achieved by the optical system, by taking a weighted average of the local shift amounts of the plurality of shift amount calculation areas with weighting based on the corrected confidence scores.

14. An image capturing apparatus comprising:
an image capturing device which includes an optical system and an image sensor which is used to generate an image and which contains a plurality of shift amount calculation areas, each of the plurality of shift amount calculation areas having a plurality of first pixels for generating a first sub-image representing a subject captured in the shift amount calculation area and a plurality of second pixels for generating a second sub-image representing the subject captured in the shift amount calculation area, wherein a shift amount representing a shift between the subject on the first sub-image and the subject on the second sub-image varies according to a distance between the image sensor and a focus position achieved by the optical system for the subject; and
a controller which causes the image capturing unit to focus on the subject, wherein the controller configured to:
identify from among the plurality of shift amount calculation areas each shift amount calculation area contained in a measurement area defined on the image sensor;
calculate, for each shift amount calculation area contained in the measurement area, a local shift amount of the second sub-image relative to the first sub-image when the subject on the first sub-image and the subject on the second sub-image best coincide with each other, and a confidence score representing a degree of certainty of the local shift amount;
correct, for each of the plurality of shift amount calculation areas contained in the measurement area, the confidence score based on at least one of a spacing between adjacent ones of the plurality of first pixels, a spacing between adjacent ones of the plurality of second pixels, and an amount of positional displacement between the plurality of first pixels and the plurality of second pixels in a direction orthogonal to an edge direction of the subject in the shift amount calculation area;
calculate a representative value representing the distance between the image sensor and the focus position achieved by the optical system, by taking a weighted average of the local shift amounts of the plurality of shift amount calculation areas contained in the measurement area, with weighting based on the corrected confidence scores; and
cause, based on the representative value, the image capturing device to focus on the subject.
